(19) United States
(12) Patent Application Publication
(10) Pub. No.: US 2018/0329225 A1
(43) Pub. Date: Nov. 15, 2018

(54) Pattern Detection at Low Signal-To-Noise Ratio

(71) Applicant: President and Fellows of Harvard College, Cambridge, MA (US)

(72) Inventors: Nancy E. Kleckner, Newton, MA (US); Frederick S. Chang, Cambridge, MA (US)

(21) Appl. No.: 15/757,883

(22) PCT Filed: Aug. 31, 2016
(86) PCT No.: PCT/US16/49706

§ 371 Date: Mar. 6, 2018

Related U.S. Application Data
(60) Provisional application No. 62/211,950, filed on Aug. 31, 2015.
(60) Provisional application No. 62/211,994, filed on Aug. 31, 2015.

(51) Int. Cl. G02B 27/58; G02B 21/16; G06K 9/00; G06K 9/62; G06T 5/00; G01N 21/64

(52) U.S. Cl. CPC G02B 27/58; G02B 21/16; G01N 21/6458; G06K 9/6277; G06T 5/002; G06K 9/00127

(57) ABSTRACT

Methods and systems for detecting and characterizing a pattern (or patterns) of interest in a low signal-to-noise ratio (SNR) data set are disclosed. One method is a two-stage Likelihood pipeline analysis that takes advantage of the benefits of a full Likelihood analysis while providing computational tractability. The two-stage pipeline may include a first stage including the application of approximate Likelihood functions in which one or more of the following assumptions or modifications may be applied: (i) the pattern of interest and background are at a specified position in a segment of the data set under examination; (ii) the SNR is low; and (iii) measurement noise can be represented in such a form that all non-position parameters of the representation are linear with respect to the derivative of the Log Likelihood versus lambda. The second stage may include a full Likelihood analysis.

### CROSS-REFERENCE TO RELATED APPLICATIONS

This application claims the benefit of priority to U.S. provisional application No. 62/211,950, filed Aug. 31, 2015, and U.S. provisional application No. 62/211,994, filed Aug. 31, 2015, both of which applications are hereby incorporated by reference in their entireties.

### FIELD OF THE DISCLOSURE

This disclosure is generally directed to pattern detection in data sets, in particular pattern detection including Likelihood analysis.

### BACKGROUND

Robust detection of a pattern at low signal-to-noise ratio (“SNR”) represents a fundamental challenge for many types of data analysis. Robustness comprises both the reliable detection of a pattern when it is present (i.e., minimized false negatives) and the failure to falsely identify a pattern as being present when, in fact, it is not (i.e., minimized false positives). Biological imaging provides a prominent example: super-resolution imaging of fluorescent point sources (“spots”), e.g., single molecules, is currently possible only in high-SNR regimes, i.e. where the “spot” is very bright.

Powerful methodologies have recently emerged which permit the reliable detection and precise localization of fluorescent objects, both spots and fluorescent objects with more complex shapes, with resolution below the optical limit set by the wavelength of light. However, thus far, known single molecule/point source methodologies (e.g., STORM, double helical point spread function analysis) require imaging in a high SNR regime. Also, methodologies for imaging objects with more complex shapes that are not based on imaging of individual point sources (for example Structured Illumination Microscopy or “SIM”), are based on imaging multiple instances of the sample of interest under different illumination conditions. A super-resolution image of the object that surpasses the optical limit is then reconstructed from this battery of images. Each component image must be obtained in a high-SNR regime for successful reconstruction.

These high SNR imaging methods require high excitation energy in order to achieve a signal that is detectable above the background, which comprises flourescence that emanates from sources other than the spot, and despite the presence of noise. High excitation energy results in photobleaching and, in living samples, phototoxicity. Because of these effects, super-resolution spot detection and localization is currently limited to the acquisition of 2D data, with 3D information extracted indirectly by modification of the optics plus appropriate data analysis (thus avoiding the need to take z-slices for each image). Moreover, time-lapse analysis in living cells is limited to a relatively small number of time points. Conversely, an unique approach has made it possible to detect fluorescent point sources and/or objects with more complex shapes in low SNR regimes (and thus low excitation energies), thereby enabling imaging of living cells with many images collected over very long time periods. (See, e.g., (1) Carlton, Peter M., et al. “Fast live simultaneous multiwavelength four-dimensional optical microscopy.” Proceedings of the National Academy of Sciences 107.37 (2010): 16016-16022; (2) Arigovindan, Muthuvel, et al. “High-resolution restoration of 3D structures from widefield images with extreme low signal-to-noise-ratio.” Proceedings of the National Academy of Sciences 110.43 (2013): 17344-17349). However, this approach does not provide super-resolution precision of localization for fluorescent point sources or for visualization of objects with more complex shapes and, moreover, is computationally-intractable for large datasets.

### SUMMARY

Methods and systems for detecting and characterizing a pattern (or patterns) of interest in a low signal-to-noise ratio (SNR) data set are disclosed herein.

An embodiment of a method of detecting a pattern of interest in a data set, the data set comprising a plurality of segments, may include calculating an approximate maximum likelihood estimate (MLE) for one or more of the plurality of segments to identify one or more pattern-of-interest candidate segments. Calculating an approximate MLE for a segment may include assuming that the pattern of interest is positioned at a specified position in the segment. The method may further include applying a full Likelihood analysis to each of the candidate segments and designating one or more of the candidate segments as including the pattern according to the result of the full Likelihood analysis.

An embodiment of a system may include a non-transitory computer-readable medium storing instructions and a processor configured to execute the instructions to perform a method of detecting a pattern in a data set, the data set comprising a plurality of segments. The method may include calculating an approximate maximum likelihood estimate (MLE) for one or more of the plurality of segments to identify one or more pattern-of-interest candidate segments. Calculating an approximate MLE for a segment may include assuming that the pattern of interest is positioned at a specified position in the segment. The method may further include applying a full Likelihood analysis to each of the candidate segments and designating one or more of the candidate segments as including the pattern according to the result of the full Likelihood analysis.

An embodiment of a method of detecting a pattern of interest in a data set, the data set comprising a plurality of segments, may include calculating a first approximate maximum likelihood estimate (MLE) for one or more of the plurality of segments with respect to a first model. The first model may include (i) the pattern of interest at the segment and (ii) a background pattern at the segment. Calculating the first approximate MLE for a segment may include assuming that the pattern of interest is positioned at a specified position in the segment. The method may further include calculating a first approximate likelihood value (LV) associated with the first approximate MLE. The method may further include calculating a second approximate MLE for the one or more segments with respect to a second model, the second model including the background pattern at the segment, and calculating a second approximate LV associated with the second approximate MLE. The method may further include determining a ratio of the first approximate LV to the second approximate LV to identify one or more pattern-of-interest candidate segments, applying a full Likelihood analysis to each of the candidate segments, and designating one or more of the candidate segments as including the pattern of interest according to the result of the full Likelihood analysis.

### BRIEF DESCRIPTION OF THE DRAWINGS

FIG. 1 is a flow chart illustrating an embodiment of a method of characterizing a pattern of interest in a data set.

FIG. 2 is a diagrammatic view of an example z-stack of two-dimensional images that may comprise an example three-dimensional data set.

FIG. 3 is a flow chart illustrating an embodiment of a first stage in a two-stage likelihood pipeline analysis.

FIG. 4 is a flow chart illustrating an embodiment of a second stage in a two-stage likelihood pipeline analysis.

FIG. 5 is a diagrammatic view of an embodiment of a system for acquiring a data set and identifying and localizing a pattern of interest in a data set.

FIG. 6A, FIG. 6B, and FIG. 6C illustrate example experimental images including a pattern of interest, background, and measurement noise, and a result of the application of an example first stage in a two-stage likelihood pipeline analysis.

FIGS. 7A, 7B, 7C, and 7D include images from an experiment in which a living yeast cell was marked, imaged, and processed in an example first stage in a two-stage Likelihood pipeline analysis.

FIG. 8 includes a set of images of the nucleoid of the bacterium E. coli, tagged with a fluorescent marker and alternatively processed in (a) an example first stage in a two-stage Likelihood pipeline analysis and (b) a known deconvolution process, to illustrate that a two-stage Likelihood pipeline analysis can be applied to provide a de-convolved image of a fluorescent object with a complex shape.

### DETAILED DESCRIPTION

The instant disclosure provides an algorithm that may be applied to reliably detect a pattern of interest (e.g., one or more fluorescent spots) in a low-SNR data set. When applied to detect fluorescent spots in biological bodies with an optical image detector (e.g., a microscope), the algorithm of the present disclosure may provide localization precision beyond the optical diffraction limit, may provide optimal resolution of overlapping spots, and may further provide accurate quantification. The algorithm of the present disclosure may enable super-resolution visualization of single molecules in three-dimensions (3D) at frequent time intervals for long, biologically-relevant time periods. The algorithm of the present disclosure may also enable super-resolution time-lapse imaging of whole objects.

The instant disclosure describes a new algorithm, a “two-stage Likelihood pipeline.” The two-stage Likelihood pipeline makes use of the Likelihood approach, which is a well-documented method for finding patterns in noisy data sets that is understood by a person of ordinary skill in the art. The Likelihood approach, in order to identify and characterize a pattern of interest, can take into account multiple components that contribute to the values of the data set. In embodiments, the Likelihood approach may take into account all components that contribute to the values of the data set. For example, in an embodiment, as described further below, a Likelihood approach may take into account the ideal theoretical natures of a pattern of interest and of the background as well as the effects of multiple types of noise, with each of these contributors to the values in the data set expressed mathematically as a function of particular parameters.

A full Likelihood approach, in its purest form (which may also be referred to herein as a “single stage” form of Likelihood analysis), would involve consideration of all possible combinations of all possible values of all of parameters across the entire data set in order to determine which particular combination of parameter values would best fit the data set. This theoretical ideal is rarely, if ever, achieved in practice because it requires a computational workload that cannot be achieved with current technology in an acceptable amount of time. As a result, various strategies have been developed that simplify the computational task, thus ameliorating the challenge of computational intractability. For example, the Markov Chain Monte Carlo method takes the approach of intelligent sampling of particular subsets of parameter values. However, this approach is slow and inefficient, and thus only applicable if the position of the pattern of interest in the data set is first approximately defined and if the number of data sets to be analyzed is restricted. A similar situation exists for the specific case of fluorescent spot detection. In one known approach, the data set is scanned by eye, or by ad hoc criteria, to determine the presence of a spot, and a full Likelihood approach is then implemented on the limited portion of the data set that includes the spot to more stringently define the presence of a spot and to provide its precise and accurate localization. See Sage, Daniel, et al. “Quantitative evaluation of software packages for single-molecule localization microscopy,” Nature methods 12.8 (2015): 717-724. This method cannot be applied to low-SNR data sets because, in such regimes, a spot may be missed by visual or “ad-hoc” criteria and thus may not actually be evaluated by the Likelihood approach. In other words, initial inspection of a data set through visual inspection or ad hoc criteria is particularly ineffective in low-SNR data sets because of an unacceptably high chance of false negatives. A general, computationally-tractable algorithm for robustly detecting and precisely localizing a pattern of interest in a large, noisy, low-SNR data set (e.g., a data set generated by 3D time lapse analysis of a fluorescent spot with imaging at frequent intervals for long time periods) does not currently exist.

The two-stage Likelihood pipeline of the instant disclosure modifies the Likelihood approach in order to both detect and localize a pattern of interest (e.g., in a large data set) in a computationally-efficient (and therefore feasible) manner. The two-stage Likelihood pipeline may provide robust spot detection and may enable both accurate (e.g., super-resolution) localization and precise localization and quantitation of detected spots. Moreover, the two-stage Likelihood pipeline may enable pattern detection and localization in low-SNR data sets.

When applied to imaging of fluorescent bodies, the two-stage Likelihood pipeline enables the collection of data at lower excitation energy relative to known methods, and therefore enables imaging and following of fluorescent bodies over longer periods of time (through capture of more images at more frequent intervals) than known methods.

In some embodiments described in this disclosure, the pattern of interest is a 3D photon distribution produced by a fluorescent point source. Along with the fluorescent point source of interest, photons also emanate from other sources in the measured environment; these photons comprise “background.” In embodiments, the data set may be a digitized set of images of the pattern of interest and the background. The images may be captured in 3D in a vertical series of planar sections. Each image in such a data set may represent the output of the detection units (i.e., pixels) of a camera and the camera may be a part of a microscope, in an embodiment. Photons impinging on these pixels from both the spot and the background are converted to electrons and then to analog-to-digital units (“ADUs”).

Where the pattern of interest is a 3D photon distribution produced by a fluorescent point source, noise in the data set may arise from two sources: (1) “photon noise,” which comprises fluctuations in the number of photons impinging on each pixel per time unit (i.e. image capture time), from both spot and background sources; and (2) “measurement noise,” which arises during the conversion of photons to ADUs. In the case of digital imaging, this measurement noise may vary from pixel-to-pixel due to mechanical defects of the detector, (e.g. broken or unreliable pixels). Additionally, edge effects may occur when the fluorescent point source is located within the data set, but so near an edge that the image does not capture the entire “spot” or when the point source is located outside of the data set, with only part of the corresponding spot located within the imaged data set.

To provide context for the two-stage Likelihood pipeline, the instant disclosure will first provide a brief description of Likelihood analysis. Next, the instant disclosure will provide a description of the two-stage Likelihood pipeline. The instant disclosure will then describe example methods that apply the two-stage Likelihood pipeline to the detection and localization of fluorescent spots in images of biological bodies. Finally, the instant disclosure will provide experimental examples of the two-stage Likelihood pipeline applied to the detection and localization of fluorescent spots and to visualization of fluorescent objects with more complex shapes.

Brief Description of Likelihood Analysis.

As noted above, the Likelihood approach may be applied to characterize (i.e., identify, define the position of, and determine an amplitude for) a pattern of interest in a data set. In one form, the Likelihood approach compares two hypotheses to each other. First, the “signal hypothesis” hypothesizes that both the pattern of interest and the background are represented in the data set and therefore mathematically models the data set as a sum of the pattern of interest and the background. An example model of the signal hypothesis is given in equation (1) below:

signal hypothesis≡λᵢ(A, B, \vec{pos_{A}}, \vec{pos_{B}})=Afᵢ(\vec{pos_{A}})+Bgᵢ(\vec{pos_{B}}) (Eq. 1)

where λᵢ is the mean value of the data set for index i, \vec{pos_{A}} is a position (e.g., (x, y, z) in an embodiment in which the data set exists in a three-dimensional Cartesian coordinate system) respective of the pattern of interest (e.g., the center of the pattern of interest), fᵢ is the distribution function of the pattern of interest at point i, A is the amplitude of the pattern of interest, gᵢ is the distribution function of the background pattern at point i, B is the amplitude of the background pattern, and \vec{pos_{B}} is a position respective of the background (e.g., the center of the background pattern). The signal hypothesis supposes that the mean value λᵢ at a point i is the sum of the pattern of interest at that point and the background pattern at that point.

For the mathematical model of the signal hypothesis, the background is itself a pattern, but one that comprises “interference” for the pattern of interest. Accordingly, in this disclosure, both a “pattern of interest” and a “background pattern” may be referenced. When used in isolation, the term “pattern” in this disclosure refers to the pattern of interest, not the background pattern.

The second hypothesis, the “null hypothesis,” hypothesizes that the pattern of interest is not present in the data set, only the background pattern, and can be conceptualized according to equation (2) below with terms defined as described above:

null hypothesis≡λᵢ(B, \vec{pos_{B}})=Bgᵢ(\vec{pos_{B}}) (Eq. 2)

The Likelihood approach compares the signal hypothesis with the null hypotheses to determine which has a higher likelihood of describing the data set. The more accurate the signal hypothesis is (i.e., the higher the likelihood associated with the signal hypothesis), and the less accurate the null hypothesis is (i.e., the lower the likelihood associated with the null hypothesis), the more likely it is that the pattern of interest is present in the data set. As will be described in further detail below, a comparison of the likelihoods of the two hypotheses may be referred to as the “Likelihood ratio” of the given data set. Although the instant disclosure will generally refer to the use of the signal hypothesis and the null hypothesis with respect to a single pattern of interest and a single background pattern, a person of skill in the art will appreciate that the teachings of the instant disclosure may readily be extended to more than one pattern of interest, such as two overlapping fluorescent spots of different emission wavelengths, for example only, and/or more than one background pattern.

As also discussed above, one or more components of the system of interest as manifested in a data set may be characterized by noise (e.g., (i) measurement noise, (ii) pattern noise, and/or (iii) background noise. Measurement noise may result from the processes involved in detecting or measuring the pattern of interest and background and/or in converting such entities to numerical form. In the case of an image, measurement noise may include, e.g., noise intrinsic to the image capture device. Pattern noise may be an intrinsic feature of a pattern to be detected. For example, in an image of a fluorophore, the pattern of interest may be noisy because of quantum variation in the number of photons emitted by the fluorophore (so-called “quantum noise”). Background noise may be an intrinsic feature of the background pattern. In an image of a fluorophore, the background pattern may include light emissions from the measurement environment and thus may also be characterized by quantum variation.

Where the pattern of interest is a fluorescent spot, both pattern noise and background noise may be described by a Poisson distribution. As will be described in greater detail later in this disclosure, these two noise effects (i.e. the effects of the fluctuations in the two different noise sources) may be additive. Accordingly, pattern noise and background noise may be jointly represented by a single Poisson distribution (as the sum of two Poisson distributions is a single new Poisson distribution). Measurement noise may be described by a Gaussian distribution with a mean and a variance that are pixel-specific parameters.

A Likelihood analysis includes respective functions for both the signal hypothesis and the null hypothesis, which may be solved to determine optimal values of A, B, \vec{pos_{A}}, and \vec{pos_{B}} (i.e., the parameter values that best describe the data set), as well as the likelihoods associated with those optimal values. It should be noted that the signal hypothesis depends on A, B, \vec{pos_{A}}, and \vec{pos_{B}}, and the null hypothesis depends only B and \vec{pos_{B}}. This process—determining optimal values for the parameters of the hypotheses and the likelihoods associated with those values—may be carried out independently for, first, a function corresponding to the signal hypothesis and, second, a function corresponding to the noise hypothesis. These functions are known as “Likelihood functions.” Each Likelihood function describes the likelihood that a given data set arose from the model that implements the corresponding hypothesis (e.g., signal or null) as a function of the parameters of the corresponding model. The Likelihood function defines the likelihood (l) that given data (e.g., a data point \vec{d_{J}}) arose from a particular model (signal or null) and is proportional (kⱼ) to the probability (P) of observing the data given the values of the parameters of the model. Equation (3) below sets forth the general form of a Likelihood function:

l(hypothesis|\vec{d_{J}})_{noiseModel}=kⱼP_{noiseModel}(\vec{d_{J}}|hypothesis) (Eq. 3)

Proportionality constant kⱼ is a data dependent constant, which means that each given dataset j is assigned its own constant kⱼ in the Likelihood function. Since this constant is a data dependent term, different Likelihood functions, e.g. from different hypotheses, that share the same data will also share the same constant. Thus, for a Likelihood ratio based on two different hypotheses operating on the same dataset, this same constant will be present in both the numerator and the denominator and will cancel out.

The Likelihood analysis, and functions of the analysis, will be described in this disclosure with reference to a data set d, in which each data point \vec{d_{J}} is an n-dimensional value having the form given in equation (4) below:

\vec{d}_{J}=[d₁, d₂, d₃, . . . dₙ]ⱼ (Eq. 4)

In an example form of a Likelihood analysis, the Likelihood function for the signal hypothesis is given and expanded in equation (5) below:

$$( Eq . 5 )$$

$$\begin{matrix}{𝓁 ( A , B , \vec{{pos}_{A}} , \vec{{pos}_{B}} \vert \vec{{d}_{J}} )}_{noiseModel} = {k}_{j} {P}_{noiseModel} ( \vec{{d}_{J}} \vert \vec{λ} ( A , B , \vec{{pos}_{A}} , \vec{{pos}_{B}} ) ) \\ = {k}_{j} {P}_{noiseModel} ( {[ {d}_{1} , {d}_{2} , {d}_{3} , … , {d}_{n} ]}_{j} \vert \\ \vec{λ} ( A , B , \vec{{pos}_{A}} , \vec{{pos}_{B}} ) ) \\ = {k}_{j} {\prod }_{i = 1}^{n} {P}_{noiseModel} ( {d}_{i} \vert {λ}_{i} ( A , B , \vec{{pos}_{A}} , \vec{{pos}_{B}} ) )\end{matrix}$$

The Likelihood function for the signal hypothesis can be solved to identify the values of the parameters (A, B, \vec{pos_{A}}, and \vec{pos_{B}}) that give the best fit of the model to the data set of interest d and to define the likelihood that the values d_{J} in the data set of interest d would occur according to the model, given those parameter values. This exercise comprises a “Maximum Likelihood Estimation.” After solving the above equation (5) (an example process for which is provided below), the identified optimal parameter values (A, B, \vec{pos_{A}}, and \vec{pos_{B}}) comprise the “Maximum Likelihood Estimate” (MLE). The Likelihood value (LV) at the MLE is related to how probable it is to see the given data \vec{d_{J}} for the given model having parameters (A, B, \vec{pos_{A}}, and \vec{pos_{B}}).

In the same example Likelihood analysis, the Likelihood function for the null hypothesis can be represented in the same general form as equation (5) above and solved to find the optimal values of B and \vec{pos_{B}} and the value of its corresponding likelihood.

Once the Likelihood functions for the signal hypothesis and the null hypothesis are solved, the Likelihood values associated with the two hypotheses can be compared with each other in a ratio. The ratio of the two likelihoods may be referred to as the “Likelihood Ratio.” The Likelihood Ratio provides a quantitative measure of the relative probabilities that the experimental data set would have arisen according to the signal hypothesis model or the null hypothesis model. Because the only difference between the two hypotheses is the presence or absence of the pattern of interest, the Likelihood ratio gives a measure of the probability that the pattern of interest is present in the data set.

A threshold can be defined for the Likelihood ratio to define the minimum value that may be considered to define the presence of the pattern of interest, with the value of the threshold at the discretion of the user. In an embodiment, the Likelihood Ratio threshold can be defined through experimentation to determine an appropriate threshold that results in an accurate determination of the presence of the pattern of interest. In embodiments, the threshold may be applied directly to the numerical form of the Likelihood Ratio. In other embodiments, the threshold may be applied to a mathematical manipulation of the Likelihood Ratio, which is also considered application of the threshold to the Likelihood Ratio for the purposes of this disclosure. Such mathematical manipulations may include, for example, defining local maxima through H-dome transformation or other local maxima approaches, all of which will be understood by a person of skill in the art.

If the Likelihood ratio indicates that the pattern of interest is present, the parameter values of the signal hypothesis model (i.e., the amplitude (A) and position (\vec{pos_{A}}) of the pattern of interest and the amplitude (B) and position (\vec{pos_{B}}) of the background) define the optimally-likely values of those parameters for that pattern of interest and background.

The Likelihood Approach, via determination of a Likelihood ratio, is a powerful tool to analyze patterns in data sets characterized by high background intensities and high levels of system noise from all sources, relative to the intensity of the pattern of interest.

Part of the power of likelihood analysis derives from the fact that it incorporates and accommodates different sources of information available in the data set. The Likelihood functions based on the signal hypothesis model and the null hypothesis model take into account not only the nature of the pattern of interest and the background pattern (e.g., for the case of a fluorescent spot, a 3D Gaussian photon distribution and, for example, a constant average level of photons that emanate from sources other than the spot, across the data set) but also the fact that the values present in any individual data set will fluctuate from one sampling of the system to another. This fluctuation comprises “noise.”

To restate the above point in another way: in principle, the value of the datum predicted to occur at each position in the data set could be a specific number that would be the same in every sampling of the system (e.g. every fluorescence imaging data set of a particular sample). However, if there is noise in the system, from any or all of the above-noted sources, that predicted value fluctuates as described by some appropriate statistical probability distribution(s) (e.g. Poisson, Gaussian, or an empirically-determined distribution), and the probability that the observed datum will be any particular value is predicted by that distribution. Conversely, given such a distribution(s), the probability that the data value actually observed would have arisen from the relevant model at the defined parameter values can be specifically defined. A unique advantage of the Likelihood approach is that it incorporates such “noise distributions” and thus can consider the effects of noise fluctuations on the probability that a given datum in a data set will a particular value.

Modeling Fluorescence Spot Image Data for Likelihood Analysis—Problems With Full Likelihood Analysis.

Likelihood analysis can find particular use in the identification and characterization of fluorescent spots in images of biological bodies. To apply a likelihood analysis for such a case, sources of noise may be modeled in the Likelihood functions for a signal hypothesis model and for a null hypothesis model. For the particular case of fluorescence spot image data, the following considerations apply. “Photon noise” (which is characteristic of both the pattern of interest and background pattern) can be described by a Poisson distribution whose mean value is the average number of photons impinging on a given pixel (λᵢ). This Poisson distribution pertains to either (i) photons from both the pattern of interest and the background pattern (in the signal hypothesis) or (ii) photons from the background pattern only (in the null hypothesis). Equation (6) below sets forth an example probability function setting forth the probability of observing a given pixel Yᵢ (i.e., the combined contributions of noise from the pattern of interest and the background pattern) in a Poisson distribution parameterized by the mean number of photons λᵢ:

$$P ( {Y}_{i} = {y}_{i} \vert {λ}_{i} ) = \frac{{λ}_{i}^{{y}_{i}}}{{y}_{i} !} {e}^{{λ}_{i}} \qquad ( Eq . 6 )$$

Another source of noise in fluorescence spot image data is (iii) measurement noise. In a particular image, a respective number of photons impinges on each pixel and is converted by the camera to some number of electrons, each of which is stored as an “analog-to-digital unit” (ADU). This conversion process is characterized by noise. This so-called “camera noise” (a form of measurement noise) may be described by a Gaussian distribution whose variance is given by the read noise of the particular pixel and whose mean value is given by the magnitude of the user-selected or system-selected “offset” used to eliminate negative ADU values. Equation (7) below sets forth an example probability function setting forth the probability of observing a given data set Xᵢ (i.e., measurement noise) in a Gaussian distribution parameterized by the read noise variance of the camera (σᵢ²) and a mean offset (μᵢ) used to eliminate negative ADU values:

$$P ( {X}_{i} = {x}_{i} \vert {μ}_{i} , {σ}_{i}^{2} ) = \frac{1}{{σ}_{i} \sqrt{2 π}} {e}^{\frac{- {( {x}_{i} - {μ}_{i} )}^{2}}{2 {σ}_{i}^{2}}} \qquad ( Eq . 7 )$$

The two types of noise, i.e. photon noise (from the pattern(s) of interest and/or the background pattern(s)) and camera noise may be independent from each other. Consequently, their effects may add to give the distribution that describes the fluctuation in ADUs. Mathematically, this additive distribution therefore may be described by convolving the distributions. In the particular case described above, this implies convolving the Poisson distribution describing the photon noise with the Gaussian distribution describing the camera noise. Equation (8) below illustrates that convolution:

$$( Eq . 8 )$$

$$\begin{matrix}{P}_{full} ( {D}_{i} = {d}_{i} \vert {μ}_{i} , {σ}_{i}^{2} , {λ}_{i} ) = {\sum }_{{x}_{i} = 0}^{∞} P ( {X}_{i} = {x}_{i} \vert {μ}_{i} , {σ}_{i} ) \cdot P ( {Y}_{i} = {d}_{i} - {x}_{i} \vert {λ}_{i} ) \\ = ( Gaussian ( {μ}_{i} , {σ}_{i}^{2} ) * Poisson ( {λ}_{i} ) ) [ {d}_{i} ]\end{matrix}$$

Given the distribution of equation (8) above, the probability of occurrence of a particular number of ADUs present at a given point in the data set (in the case of 3D fluorescence images, at a given pixel or voxel) can be determined. The mean value of the Poisson distribution may be defined by the predicted photon level value at that pixel, whereas the camera noise Gaussian distribution may be defined by empirical calibration measurements for each pixel in a particular camera/imaging setup.

The standard Likelihood approach (including noise modeled according to equation (8) above) cannot practically be applied if the data set is very large, if the models involve multiple parameters, and/or for complex spatial and/or numerical distributions of noise, because it would be computationally intractable. This intractability arises from the computational complexity required to determine an MLE for the signal hypothesis (or any hypotheses) in those situations.

The computational intractability of a full Likelihood analysis applies to fluorescent spot analysis—specifically, to initial detection of fluorescent spots in image data. As a result, existing approaches include the use of ad hoc computational criteria and/or human visual inspection of images to initially identify the presence of a spot. After identifying the region of the data set containing a spot, existing approaches then may use a full Likelihood approach to determine the specific location of the spot. For example, some existing approaches use an iterative “hill-climbing” exercise that defines the MLE for a small region of the data that is defined as containing a spot based on ad hoc computational criteria and/or human visual examination. A hill-climbing exercise starts from a particular position in parameter space of the Likelihood function, evaluates the slope of the Likelihood function at that point, and follows that slope in the upward direction in parameter space to find a maximum Likelihood value at the position where the derivative of the Likelihood function is zero.

A hill-climbing exercise cannot practically be used to initially identify a spot because, if the wrong starting point were chosen, the MLE may be determined for a local maximum in the data set that does not, in fact, represent a spot. The result would be loss of robustness, i.e. detection of a spot where none is present or failure to detect a spot when one is present, or detection of a spot with incorrect parameters specified. Thus, to robustly define the presence of a spot by a hill-climbing Likelihood approach, it would be necessary to carry out the hill-climbing exercise beginning from every position in the parameter set. The iterative nature of the hill-climbing approach is very computationally expensive, and the computational load required to carry out hill-climbing starting at every position is a parameter set is prohibitive. Thus, as noted above, known approaches utilize ad hoc criteria and/or human visual inspection detect the presence of a spot at an approximate position in the data set.

As an improvement on the above approaches—e.g., a full, single-stage Likelihood analysis to identify and locate a pattern of interest, or a manual or computational identification of a pattern through ad-hoc criteria followed by a Likelihood analysis to localize and further characterize the pattern of interest—a novel “two-stage Likelihood pipeline” may be used to take advantage of the benefits of a Likelihood analysis while reducing computational workload to a practical level. In this novel conceptual framework, the Likelihood approach, or a version thereof, may be used at both stages of the analysis. This contrasts with other known methods, in which the Likelihood approach, when applied, is reserved for the final stage, thus losing out on its potential benefits during initial stages.

Improvement to a Full Likelihood Analysis—Two Stage Likelihood Pipeline.

The two-stage Likelihood pipeline includes two stages, described in turn below. First, in Stage I, a modified Likelihood analysis may be performed to determine the presence of zero, one or more spot candidate locations. Second, in Stage II, a full Likelihood analysis may be carried out at one or more of the spot candidate locations identified in Stage Ito verify the presence of (i.e., to formally detect) and to localize and determine the amplitude of spots at the candidate locations.

Two-Stage Likelihood Pipeline—Stage I.

The full data set is considered in small units that may be referred to in this disclosure as “patches” or “segments.” In an embodiment, the size of a patch or segment may be slightly larger than that expected for a fluorescent spot. In embodiments in which the pattern of interest is something other than a fluorescent spot, patch size may be selected as appropriate. In embodiments in which each data point is a pixel or voxel, a patch or segment may be as small as a single pixel or voxel, or may be a set of pixels or voxels that contain a pattern of interest. In embodiments, a patch or segment may include a contiguous set of adjacent pixels or voxels. Additionally or alternatively, a patch or segment may include pixels or voxels that are non-contiguous or non-adjacent. Patches may be defined for every position in the data set. In an embodiment, every data point in the data set may be included in at least one patch. A Likelihood analysis may be carried out for each patch with three simplifying modifications: (i) the 3D Gaussian distribution corresponding to the pattern of interest (i.e., the spot) and the distribution corresponding to the background may be assumed to be positioned at some respective specified positions within the patch; (ii) the measurement noise may be described as a Poisson distribution, rather than as a Gaussian distribution; and (iii) the intensity of the mean photon values may be assumed to be low relative to measurement noise. This disclosure will discuss embodiments in which the specified location of the pattern of interest and/or the background pattern within a patch or segment is the center of the patch or segment. However, the two-stage Likelihood pipeline is not so limited. Rather, it should be understood that the specified position of the pattern of interest within a patch or segment may alternatively be some position other than the center, in embodiments.

A signal hypothesis model (incorporating both the pattern of interest and background) and a null hypothesis model (incorporating only background) based on the above assumptions offer two simplifications over a standard, full Likelihood approach as described above. First, the number of variable parameters is decreased because the positions of the pattern of interest and of the background pattern are specified, rather than variable. Thus, in the signal hypothesis model, there are only two variable parameters, A and B. For the same reason, in the null hypothesis model, there is just one variable parameter, B. As a result, at stage I, example signal hypothesis and null hypothesis models may be described according to equations (9) and (10) below:

signal hypothesis≡λᵢ(A, B, \vec{cen})=Afᵢ(\vec{cen})+B (Eq. 9)

null hypothesis≡λᵢ(B)=B (Eq. 10)

where \vec{cen} represents a specified position at the center of the patch or segment.

For a fluorescent spot existing in a three-dimensional data set, fᵢ is a 3D Gaussian distribution, corresponding to the distribution of photons emanating from a fluorescent point source, A is the amplitude of that Gaussian distribution, \vec{pos} (in x, y, z) defines the position of the center of the Gaussian within the 3D data set, and B is the amplitude of the background.

A second simplification offered by the above assumptions is that, because the effects of noise can be reasonably approximated by describing the camera noise as a Poisson distribution, all noise components (i.e., (i) photon noise for the pattern and/or background and (ii) camera noise can be incorporated into a single Poisson distribution that is the sum of the two Poisson components, as set forth in the progression of equations (11)-(14) below:

$$( Eq . 11 )$$

$${P}_{full} ( {d}_{i} \vert {μ}_{i} = 0 , {σ}_{i}^{2} , {λ}_{i} ) = ( Gaussian ( 0 , {σ}_{i}^{2} ) * Poisson ( {λ}_{i} ) ) [ {d}_{i} ]$$

$$( Eq . 12 )$$

$$\begin{matrix}{P}_{full} ( {d}_{i} + {σ}_{i}^{2} \vert {μ}_{i} = 0 , {σ}_{i}^{2} , {λ}_{i} ) = ( Gaussian ( {σ}_{i}^{2} , {σ}_{i}^{2} ) * Poisson ( {λ}_{i} ) ) [ {d}_{i} ] \\ \approx ( Poisson ( {σ}_{i}^{2} ) * Poisson ( {λ}_{i} ) ) [ {d}_{i} ] ( Eq . 13 )\end{matrix}$$

$$( Eq . 14 )$$

$${P}_{PoissPoiss} ( {d}_{i} \vert {μ}_{i} = 0 , {σ}_{i}^{2} , {λ}_{i} ) = Poisson ( {σ}_{i}^{2} + {λ}_{i} ) [ {d}_{i} + {σ}_{i}^{2} ]$$

Equation (14), stated as a probability function, can also be described as a Likelihood function, as in equation (15) below:

$${ℒ ( hypothesis \vert \vec{{d}_{J}} )}_{PoissPoiss} = Log ( {𝓁}_{PoissPoiss} ) = {\sum }_{i = 1}^{n} log ( \frac{1}{( {d}_{i} + {σ}_{i}^{2} ) !} ) + {\sum }_{i = 1}^{n} ( {d}_{i} + {σ}_{i}^{2} ) log ( {λ}_{i} + {σ}_{i}^{2} ) - {\sum }_{i = 1}^{n} {λ}_{i} - {\sum }_{i = 1}^{n} {σ}_{i}^{2} \qquad ( Eq . 15 )$$

Taking the logarithm of equation (15) yields equation (16) below:

$${ℒ ( hypothesis \vert \vec{{d}_{J}} )}_{PoissPoiss} = log ( {𝓁}_{PoissPoiss} ) = {\sum }_{i = 1}^{n} log ( \frac{1}{( {d}_{i} + {σ}_{i}^{2} ) !} ) + {\sum }_{i = 1}^{n} ( {d}_{i} + {σ}_{i}^{2} ) log ( {λ}_{i} + {σ}_{i}^{2} ) - {\sum }_{i = 1}^{n} {λ}_{i} - {\sum }_{i = 1}^{n} {σ}_{i}^{2} \qquad ( Eq . 16 )$$

The derivative of equation (16) with respect to λᵢ, which may be used to derive the MLE for (A, B), as described below, is shown in equation (17) below:

$$\frac{\partial {ℒ}_{PoissPoiss}}{\partial {λ}_{i}} = {\sum }_{i = 1}^{n} \frac{{d}_{i} - {λ}_{i}}{{λ}_{i} + {σ}_{i}^{2}} \qquad ( Eq . 17 )$$

To derive the approximate MLE for (A, B) at a given \vec{ₚₒₛ} from equation (16), the following process may be followed, in an embodiment: (1) assume the intensity λᵢ (i.e., the data representing the pattern of interest) is low relative to the camera noise σᵢ², such that the additive data and camera noise, represented as νᵢ²+λᵢ, can be reduced to σᵢ² (as in equation (18) below):

$$\frac{\partial {ℒ}_{PoissPoiss}}{\partial {λ}_{i}} {\vert}_{approx} = {\sum }_{i = 1}^{n} \frac{{d}_{i} - {λ}_{i}}{{λ}_{i} + {σ}_{i}^{2}} \approx {\sum }_{i = 1}^{n} \frac{{d}_{i} - {λ}_{i}}{{λ}_{i} + {σ}_{i}^{2}} = {\sum }_{i = 1}^{n} \frac{{d}_{i} - {λ}_{i}}{{σ}_{i}^{2}} \qquad ( Eq . 18 )$$

(2) take the derivatives of the L_{PoissPoiss} with respect to A, B, and (3) set each derivative as equal to zero (as in equations (19) and (20) below, which represent the A, B derivatives of equation (18) as applied to the signal hypothesis model):

$$\begin{matrix}0 = \frac{\partial {ℒ}_{PoissPoiss}}{\partial A} = \frac{\partial {ℒ}_{PoissPoiss}}{\partial {λ}_{i}} \frac{\partial {λ}_{i}}{\partial A} = {\sum }_{i = 1}^{n} \frac{{d}_{i} - ( {Af}_{i} ( \vec{pos} ) + B )}{{σ}_{i}^{2}} {f}_{i} ( \vec{pos} ) & ( Eq . 19 ) \\ 0 = \frac{\partial {ℒ}_{PoissPoiss}}{\partial B} = \frac{\partial {ℒ}_{PoissPoiss}}{\partial {λ}_{i}} \frac{\partial {λ}_{i}}{\partial B} = {\sum }_{i = 1}^{n} \frac{{d}_{i} - ( {Af}_{i} ( \vec{pos} ) + B )}{{σ}_{i}^{2}} & ( Eq . 20 )\end{matrix}$$

The summations can be treated as scalars, and thus {A,B} can be solved by matrix inversion. Equations (21) and (22) below illustrate this derivation as applied to equations (19) and (20), respectively, and equation (23) below illustrates the setup of the matrix for inversion:

$$\begin{matrix}A {\sum }_{i = 1}^{n} \frac{{{f}_{i} ( \vec{pos} )}^{2}}{{σ}_{i}^{2}} + B {\sum }_{i = 1}^{n} \frac{{f}_{i} ( \vec{pos} )}{{σ}_{i}^{2}} - {\sum }_{i = 1}^{n} \frac{{f}_{i} ( \vec{pos} ) {d}_{i}}{{σ}_{i}^{2}} = 0 & ( Eq . 21 ) \\ A {\sum }_{i = 1}^{n} \frac{{f}_{i} ( \vec{pos} )}{{σ}_{i}^{2}} + B {\sum }_{i = 1}^{n} \frac{1}{{σ}_{i}^{2}} - {\sum }_{i = 1}^{n} \frac{{d}_{i}}{{σ}_{i}^{2}} = 0 & ( Eq . 22 )\end{matrix}$$

$$[ \begin{matrix}{\sum }_{i = 1}^{n} \frac{{{f}_{i} ( \vec{pos} )}^{2}}{{σ}_{i}^{2}} & {\sum }_{i = 1}^{n} \frac{{f}_{i} ( \vec{pos} )}{{σ}_{i}^{2}} \\ {\sum }_{i = 1}^{n} \frac{{f}_{i} ( \vec{pos} )}{{σ}_{i}^{2}} & {\sum }_{i = 1}^{n} \frac{1}{{σ}_{i}^{2}}\end{matrix} ] [ \begin{matrix}A \\ B\end{matrix} ] = [ \begin{matrix}{\sum }_{i = 1}^{n} \frac{{f}_{i} ( \vec{pos} ) {d}_{i}}{{σ}_{i}^{2}} \\ {\sum }_{i = 1}^{n} \frac{{d}_{i}}{{σ}_{i}^{2}}\end{matrix} ] \qquad ( Eq . 23 )$$

Equation (23) above may be solved for A and B to derive the stage I MLE of those parameters for a single patch. To extend the solution to the entire data set, the dot product of,

$$e . g . , equation ( 21 ) ( {\sum }_{i = 1}^{n} \frac{{f}_{i} ( \vec{pos} ) {d}_{i}}{{σ}_{i}^{2}} )$$

may be generalized to convolution for the entire data set, yielding

$${Σ}_{k ∈ S} \frac{{{f}_{k} ( \vec{cen} )}^{2}}{{σ}_{i - k}^{2}} ,$$

to complete the algebra for total dataset analysis by the approximate MLE of Stage I. If fₖ is not symmetric, then the orientation may be flipped in all dimensions to solve equation (23), as set forth in equation (24) below:

$$[ \begin{matrix}{Σ}_{k ∈ S} \frac{{f}_{k}^{2} ( \vec{cen} )}{{σ}_{i - k}^{2}} & {Σ}_{k ∈ S} \frac{{f}_{k} ( \vec{cen} )}{{σ}_{i - k}^{2}} \\ {Σ}_{k ∈ S} \frac{{f}_{k} ( \vec{cen} )}{{σ}_{i - k}^{2}} & {Σ}_{k ∈ S} \frac{1}{{σ}_{i - k}^{2}}\end{matrix} ] [ \begin{matrix}{A}_{i} \\ {B}_{i}\end{matrix} ] = [ \begin{matrix}{Σ}_{k ∈ S} {f}_{k} ( \vec{cen} ) \frac{{d}_{i - k}}{{σ}_{i - k}^{2}} \\ {Σ}_{k ∈ S} \frac{{d}_{i - k}}{{σ}_{i - k}^{2}}\end{matrix} ] \qquad ( Eq . 24 )$$

Computational tractability may be provided through the use of a Fast Fourier Transform analog of the convolution operator, or for the case of a 3D Gaussian, by separable convolution, in embodiments.

Solving equation (23) for A gives the approximate MLE of Aᵢ (with the assumption that the pattern of interest is centered at point i) for the signal hypothesis, as given by equation (25) below:

$$( Eq . 25 )$$

$${A}_{i} = \frac{( {Σ}_{k ∈ S} \frac{{d}_{i - k}}{{σ}_{i - k}^{2}} ) {Σ}_{k ∈ S} \frac{{f}_{k} ( \vec{cen} )}{{σ}_{i - k}^{2}} ( {Σ}_{k ∈ S} \frac{1}{{σ}_{i - k}^{2}} ) {Σ}_{k ∈ S} \frac{{d}_{i - k} {f}_{k} ( \vec{cen} )}{{σ}_{i - k}^{2}}}{{( {Σ}_{k ∈ S} \frac{{f}_{k} ( \vec{cen} )}{{σ}_{i - k}^{2}} )}^{2} - ( {Σ}_{k ∈ S} \frac{1}{{σ}_{i - k}^{2}} ) {Σ}_{k ∈ S} \frac{{{f}_{k} ( \vec{cen} )}^{2}}{{σ}_{i - k}^{2}}}$$

Solving equation (23) for B gives the approximate MLE of Bᵢ (once again, with the assumption that the pattern of interest is centered at point i) for the signal hypothesis, as given by equation (26) below:

$$( Eq . 26 )$$

$${B}_{i} = \frac{( {Σ}_{k ∈ S} \frac{{f}_{k} ( \vec{cen} )}{{σ}_{i - k}^{2}} ) {Σ}_{k ∈ S} \frac{{d}_{i - k} {f}_{k} ( \vec{cen} )}{{σ}_{i - k}^{2}} ( {Σ}_{k ∈ S} \frac{{d}_{i - k}}{{σ}_{i - k}^{2}} ) {Σ}_{k ∈ S} \frac{{{f}_{k} ( \vec{cen} )}^{2}}{{σ}_{i - k}^{2}}}{{( {Σ}_{k ∈ S} \frac{{f}_{k} ( \vec{cen} )}{{σ}_{i - k}^{2}} )}^{2} - ( {Σ}_{k ∈ S} \frac{1}{{σ}_{i - k}^{2}} ) {Σ}_{k ∈ S} \frac{{{f}_{k} ( \vec{cen} )}^{2}}{{σ}_{i - k}^{2}}}$$

Equations (24) and (25) above may be solved for A and B to determine the MLE for the signal hypothesis at a single patch, or segment, of the data set. Thus, equations (25) and (26) may be applied to all patches in the dataset, solving for {Aᵢ, Bᵢ} for all positions i and assuming that the spot pattern is centered in the patch at position \vec{cen}. As noted above, in other embodiments, the spot pattern may be assumed to be centered or located at some point in each patch or segment other than the center.

To determine the approximate MLE for the null hypothesis model, a similar analysis to that set forth with respect to equations (19)-(23) above may be carried out, but with equation (18) applied to the null hypothesis model instead of the signal hypothesis model, yielding the following equation (27) for the approximate MLE of Bᵢ for the null hypothesis model:

$${B}_{i} = \frac{{Σ}_{k ∈ S} \frac{{d}_{i - k}}{{σ}_{i - k}^{2}}}{{Σ}_{k ∈ S} \frac{1}{{σ}_{i - k}^{2}}} \qquad ( Eq . 27 )$$

For each given patch, the MLEs for the signal hypothesis model and the null hypothesis model may be calculated and used to determine the Likelihood ratio for that patch and a resulting Likelihood ratio landscape with equations (28)-(30) below, where equation (28) is the result of integrating equation (18), equation (29) is the application of equation (28) to the signal hypothesis model, and equation (30) is the application of equation (28) to the null hypothesis:

$$\begin{matrix}{ℒ}_{approx} = \int \frac{\partial {ℒ}_{PoissPoiss}}{\partial {λ}_{i}} {\vert}_{approx} \partial {λ}_{i} + C \approx - {\sum }_{i = 1}^{n} \frac{{( {d}_{i} - {λ}_{i} )}^{2}}{{σ}_{i}^{2}} & ( Eq . 28 ) \\ {ℒ}_{approx , i}^{signal} = - {A}_{i} ( {A}_{i} {Σ}_{k ∈ S} \frac{{{f}_{k} ( \vec{cen} )}^{2}}{{σ}_{i - k}^{2}} + 2 {B}_{i} {Σ}_{k ∈ S} \frac{{f}_{k} ( \vec{cen} )}{{σ}_{i - k}^{2}} - 2 {Σ}_{k ∈ S} \frac{{f}_{k} ( \vec{cen} ) {d}_{i - k}}{{σ}_{i - k}^{2}} ) + {B}_{i}^{2} ( - {Σ}_{k ∈ S} \frac{1}{{σ}_{i - k}^{2}} ) + 2 {B}_{i} ( {Σ}_{k ∈ S} \frac{{d}_{i - k}}{{σ}_{i - k}^{2}} ) - {Σ}_{k ∈ S} \frac{{d}_{i - k}^{2}}{{σ ( u - x )}^{2}} & ( Eq . 29 ) \\ {ℒ}_{approx , i}^{null} = {B}_{i}^{2} ( - {Σ}_{k ∈ S} \frac{1}{{σ}_{i - k}^{2}} ) + 2 {B}_{i} ( {Σ}_{k ∈ S} \frac{{d}_{i - k}}{{σ}_{i - k}^{2}} ) - {Σ}_{k ∈ S} \frac{{d}_{i - k}^{2}}{{σ}_{i - k}^{2}} & ( Eq . 30 )\end{matrix}$$

In an embodiment, a Likelihood ratio based on equations (29) and (30) is given by equation (31) below:

[symbol]

R_{approx,i}^{signal/null}= [symbol] _{approx,i}^{signal}− [symbol] _{approx,i}^{null} (Eq. 31)

Likelihood ratios may be determined for each patch, or segment, in the data set according to the equations above. In the case of fluorescence image data, where a patch is present centered on each pixel or voxel in the data set, a Likelihood ratio may be determined for each such position. The Likelihood ratios for each segment patch may be compared to a threshold such that, above a minimum value of the Likelihood ratio, a patch is determined to have a reasonable probability of including a spot. These patches may be termed “candidate spot regions,” “candidate spot patches,” or “candidate spot segments” in this disclosure. The threshold may be selected or determined experimentally, in embodiments, to achieve an appropriate balance between sensitivity and over-inclusiveness (i.e., to minimize false positives and false negatives).

The stage I analysis set forth above is set forth with respect to identification of fluorescent spots in a data set comprising 3D image data, but a person of skill in the art will appreciate that the approach is readily applicable to many other types of patterns and backgrounds in many other types of data sets. To that end, the approximate MLE of Aᵢ for the signal hypothesis model for a general case is given in equation (32) below:

$$( Eq . 32 )$$

$${A}_{i} = \frac{( {Σ}_{k ∈ S} \frac{{d}_{i - k} {g}_{k} ( \vec{cen} )}{{σ}_{i - k}^{2}} ) {Σ}_{k ∈ S} \frac{{f}_{k} ( \vec{cen} ) {g}_{k} ( \vec{cen} )}{{σ}_{i - k}^{2}} - ( {Σ}_{k ∈ S} \frac{{d}_{i - k} {f}_{k} ( \vec{cen} )}{{σ}_{i - k}^{2}} ) {m}_{k ∈ S} \frac{{{g}_{k} ( \vec{cen} )}^{2}}{{σ}_{i - k}^{2}}}{{( {Σ}_{k ∈ S} \frac{{f}_{k} ( \vec{cen} ) {g}_{k} ( \vec{cen} )}{{σ}_{i - k}^{2}} )}^{2} - ( {Σ}_{k ∈ S} \frac{{{f}_{k} ( \vec{cen} )}^{2}}{{σ}_{i - k}^{2}} ) {Σ}_{k ∈ S} \frac{{{g}_{k} ( \vec{cen} )}^{2}}{{σ}_{i - k}^{2}}}$$

The approximate MLE of B ᵢ for the signal hypothesis model for a general case is given in equation (33) below:

$$( Eq . 33 )$$

$${B}_{i} = \frac{( {Σ}_{k ∈ S} \frac{{{f}_{k} ( \vec{cen} )}^{2}}{{σ}_{i - k}^{2}} ) {Σ}_{k ∈ S} \frac{{d}_{i - k} {g}_{k} ( \vec{cen} )}{{σ}_{i - k}^{2}} - ( {Σ}_{k ∈ S} \frac{{d}_{i - k} {f}_{k} ( \vec{cen} )}{{σ}_{i - k}^{2}} ) {Σ}_{k ∈ S} \frac{{f}_{k} ( \vec{cen} ) {g}_{k} ( \vec{cen} )}{{σ}_{i - k}^{2}}}{- {( {Σ}_{k ∈ S} \frac{{f}_{k} ( \vec{cen} ) {g}_{k} ( \vec{cen} )}{{σ}_{i - k}^{2}} )}^{2} + ( {Σ}_{k ∈ S} \frac{{{f}_{k} ( \vec{cen} )}^{2}}{{σ}_{i - k}^{2}} ) {Σ}_{k ∈ S} \frac{{{g}_{k} ( \vec{cen} )}^{2}}{{σ}_{i - k}^{2}}}$$

As a result of the above analysis, determination of MLEs for all patches in a large data set, for each model, and the corresponding Likelihood Ratios, are computationally tractable. For example, in an embodiment given present-day computing resources, the determination of MLEs for all patches in an example fluorescence image data set may take approximately a minute per large 3D image data set.

In addition, although the instant disclosure discusses embodiments in which the signal hypothesis includes one linear parameter (A) associated with the signal pattern and one linear parameter (B) associated with the background pattern, the techniques and methods of this disclosure may be readily applied to any number of linear parameters associated with the signal pattern and/or the background pattern. In the general case above, for the signal hypothesis≡λᵢ(A, B, \vec{pos_{A}}, \vec{pos_{B}})=Afᵢ(\vec{pos_{A}})+Bgᵢ(\vec{pos_{B}}), the parameters A and B are linearly related to λᵢ and for a given data set and specified positions, A and B may be solved algebraically by the using the notation described in equation (23). Consequently, all linear parameters for any given hypothesis can be solved for any n number of patterns since these linear parameters can be manipulated into the matrix notation described in equation (23). Ultimately, for a hypothesis a₁f₁(\vec{x₁})+a₂f₂(\vec{x₂})+. . . +aₙfₙ(\vec{xₙ}) a set of amplitude parameters {a₁, a₂, . . . aₙ} can be solved directly by the approximate Likelihood for each pattern {f₁, f₂, . . . , fₙ} given each position {\vec{x₁}, \vec{x₂}, . . . , \vec{xₙ}} for a given data set.

In embodiments, the result of Stage I of the two-stage Likelihood pipeline is definition of one or more candidate patches or segments. As set forth below, those candidate patches or segments may then be subjected to a full Likelihood analysis to characterize (i.e., confirm (or not) the existence of, and determine the intensity and exact location of) the corresponding patterns of interest (i.e., spots) that may be present in those candidate patches or segments.

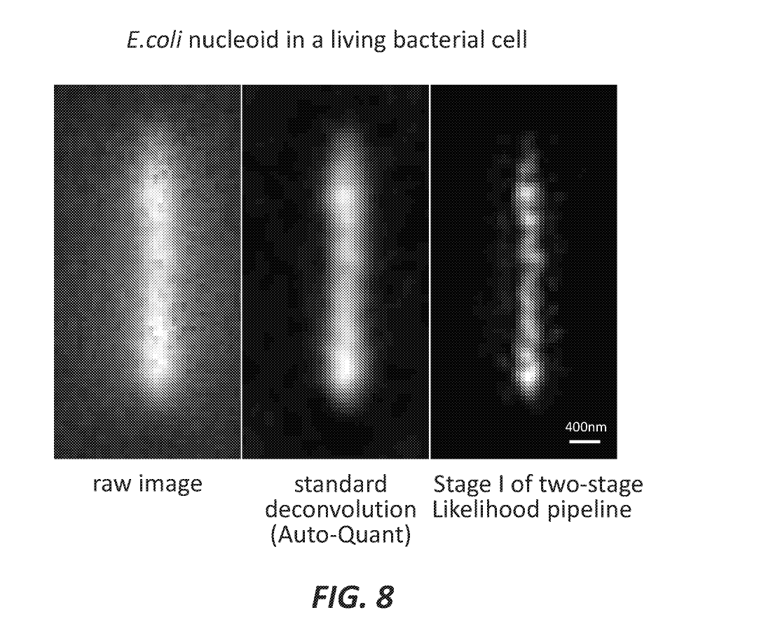

Stage I analysis has another important feature: it can be used to reverse systematic distortions that arise during data collection. This is achieved if, during Stage I analysis, via the signal hypothesis, the pattern of interest fᵢ is chosen so as to match the shape of the systematic distortion. This can be illustrated for the case of image analysis, where an imaged object is systematically distorted by physical limitations of the optics. Correction for such distortion is called deconvolution. For the application of fluorescent imaging, the systematic distortion for the imaging system involved is defined by the Point Spread Function of the lens. By Stage I analysis, via the signal hypothesis, deconvolution of a fluorescence image may be achieved by defining fᵢ as the Point Spread Function of the lens. An experimental example of the use of a Stage I analysis for deconvolution is shown in FIG. 8 and will be described later in this disclosure.

It should also be noted that, in fluorescence imaging, Stage I analysis can be applied not only to a spot, but to a fluorescent object with a more complex shape (e.g., a bacterial nucleoid). Such an object may be illuminated by many individual fluorophores and thus may comprise the superposition of many spots. Such an image comprises the summed output of the large number of point sources decorating that complex object, i.e. is one continuum of different spot densities. Upon application of the Stage I signal hypothesis, the output of the parameter A at all positions in the data set may provide an image of such an object. Moreover, when this exercise is carried out with fᵢ equal to the distortion (i.e. the Point Spread Function), the output of the parameter A at all positions in the data set may provide the true, undistorted version of the object.

Two-Stage Likelihood Pipeline—Stage II.

An example Likelihood function for the signal hypothesis model having a full noise model for a fluorescent image data set is set forth in equation (34) below:

l(hypothesis|\vec{d_{J}})_{full}=kⱼΠᵢ₌₁ⁿP_{full}(dᵢ|λᵢ(A, B, \vec{pos}))=kⱼΠᵢ₌₁ⁿ(Gaussian(μᵢ, σᵢ²)*Poisson(λᵢ(A, B, \vec{pos})))[dᵢ] (Eq. 34)

A person of skill in the art will appreciate how to construct a similar full Likelihood function for the null hypothesis model, as the Likelihood approach is well documented and understood. Similarly, a person of skill in the art will appreciate how to solve for A and B and \vec{pos} to determine the Likelihood ratio respective of each candidate segment or patch as a function of the values of those parameters.

The data set at stage II comprises the data from the original data set d that is within or around the candidate spot segments or patches. A Likelihood ratio may be determined for each candidate spot segment, and each ratio may be compared to a second threshold. This second threshold may be separately determined or selected from the first threshold, in embodiments. This Likelihood ratio may provide the final definition of whether a spot is present or not.

The full Likelihood analysis at Stage II may differ from the approximated Likelihood analysis off Stage I. First, the Likelihood functions used in stage II may be fully-detailed Likelihood functions, thus providing optimal definition of MLEs in Stage II. For example, in the case of spot detection and characterization, the noise per pixel may be represented as a (Poisson*Gaussian) distribution. Second, the values of x, y, and z (i.e., the components of \vec{pos}) may vary throughout the analyzed region in Stage II, rather than being fixed at the center of a patch as in Stage 1. As a result of these two features, for a region defined as containing a spot (i.e., a candidate segment), analysis of the MLE for the signal hypothesis model for that region will yield not only the values of parameters A and B (i.e., intensities of the spot itself and of the background), but also the position of the spot in the three dimensions at sub-pixel values of x, y and z. MLE determinations may be made in Stage II through a hill-climbing exercise or other appropriate methods, in embodiments.

As noted above, a full Likelihood analysis for fluorescent spot detection is limited in known methods by the need to initially identify candidate spot locations manually and/or by ad-hoc manual or computational criteria. The two-stage Likelihood pipeline overcomes this limitation through the use of minimally-invasive approximations of the full Likelihood functions at Stage I. Furthermore, the estimates of A and B and x, y, z provided at Stage I may generally be similar to the precisely-defined global maxima provided by the fully detailed Likelihood analysis of Stage II. Thus, if a hill climbing exercise is applied in Stage II to each candidate spot region, it can be seeded by (i.e. begin with) the parameter values of the signal hypothesis and the null hypothesis defined at Stage I. For application according to the signal hypothesis, the starting point for this exercise may be provided by the values of A, B, x, y and z defined by the Stage I MLE according to that hypothesis. For application according to the null hypothesis, this starting point may be provided by the value of B defined by the Stage I MLE, where the value of B is the same at every position, thus removing x, y and z as variables. Seeding the hill-climbing exercise provides computational tractability without the risks of (i) climbing an irrelevant hill and thus detecting a spot where none is present, (ii) failing to detect a spot when one is present, or (iii) detecting of a spot with incorrect parameters specified. The outcome of the hill-climbing exercise is, for each hypothesis, a Likelihood landscape in the corresponding 5-parameter space (signal hypothesis) or 1-parameter space (null hypothesis). In each case, the position in the parameter space with the highest Likelihood comprises the MLE; and the ratio of the Likelihood values at the MLEs for the two hypotheses comprises the Likelihood Ratio for that candidate spot region. The value of the Likelihood Ratio provides a measure of the probability that a spot is present; and the corresponding values of all parameters corresponding to the MLE of the signal hypothesis yield the intensity of the spot (A) and of the background (B) and the location of the spot (in (x, y, z), which may be at sub-pixel resolution) in the data set. In summary, overall, the effects of combining Stage I and Stage II in the Two-stage Likelihood Pipeline confer the advantages of a full Likelihood approach with respect to robust spot detection, precise and accurate spot localization and quantification of spot and background intensities without the unmanageable computational complexity of the standard Likelihood approach.

Example Methods Applying the Two-Stage Likelihood Pipeline.

As noted above, the two-stage Likelihood pipeline may find particular use with data sets having a low signal-to-noise ratio. One such type of data set is a data set including one or more images of a biological body under study to characterize one or more fluorophores. The photon output of such fluorophores is proportional to the intensity of the excitation energy applied to the fluorophores. By enabling low-SNR characterization of fluorophores, the two-stage Likelihood pipeline enables the use of low excitation energy, thereby reducing cell toxicity from excitation energy. Low-SNR regimes also minimize destruction of the fluorophores that occurs due to excitation (known as “photobleaching”). The following methods are generally directed to characterization of fluorophores using the two-stage Likelihood pipeline, but it will be appreciated that the two-stage Likelihood pipeline may find use with many types of data sets.

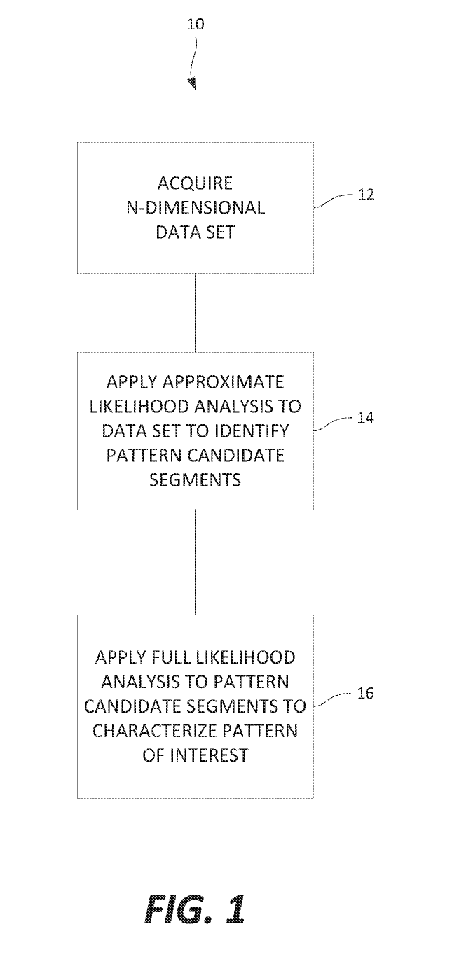

FIG. 1 is a flow chart illustrating an embodiment of a method 10 of identifying and characterizing a pattern of interest in a data set. The method may be or may include one or more aspects of the two-stage Likelihood pipeline, described above. The method may begin with a step 12 of acquiring an N-dimensional data set. The step 12 of acquiring the N-dimensional data set may include acquiring (e.g., by electronic transmission) one or more pre-captured images. Additionally or alternatively, the step 12 of acquiring the N-dimensional data set may include capturing one or more images with an image capture device and/or controlling or otherwise communicating with an image capture device to cause the image capture device to capture one or more images. The data set may include 3D imaging data captured using fluorescence microscopy, in an embodiment. For ease of reference, the method 10 will be described with respect to an embodiment in which the data set includes 3D imaging data captured using fluorescence microscopy, where each data point has the form given in equation (4) of this disclosure. It should be understood, however, that in other embodiments, the data set may include another type of imaging data and/or non-imaging data. The method 10 will also be described with reference to a fluorescent spot as the pattern of interest. It should be understood, however, that the method is more broadly applicable to other patterns.

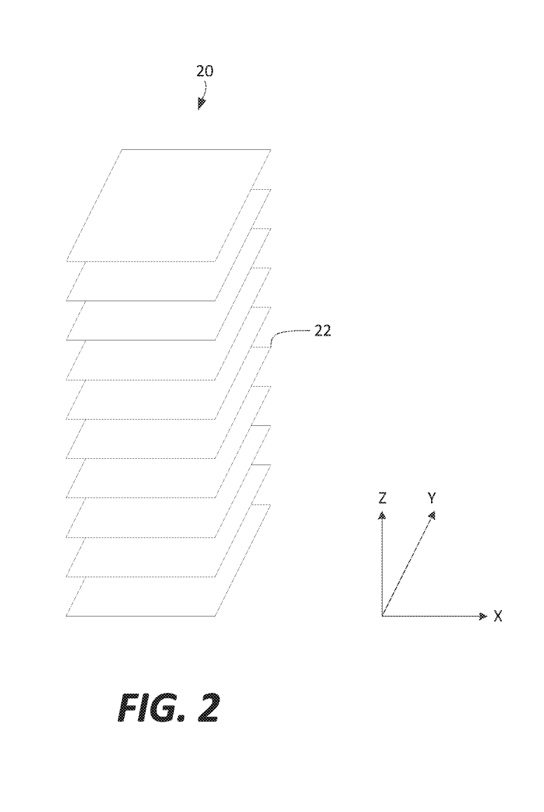

In an embodiment, the 3D dataset may include multiple images captured at multiple respective 2D focal planes using a microscope, with each of the 2D focal plane images having x- and y-dimensions and the third z-dimension corresponding to a depth dimension along the different focal plane images. FIG. 2 is a diagrammatic illustration of a 3D dataset 20 that may be captured, acquired, and/or processed in accordance with some embodiments of the method 10. As shown in FIG. 2, the z-dimension of the 3D dataset 20 may include a plurality of images 22 captured at different focal planes.

Although ten different focal plane images 22 are illustrated in FIG. 2, it should be understood that any suitable number of images at any suitable number of focal planes may be included in the 3D dataset (also colloquially referred to herein as a “z-stack” of images or a “z-series”).

In some embodiments, the 3D dataset may be acquired using a conventional epi-fluorescence illumination microscope in which images from multiple focal planes are acquired sequentially by physically moving the position of the microscope stage up/down (e.g., in the z-direction). The position of the stage may be manually operated or automatically controlled by a controller including, but not limited to, a computer processor or one or more circuits configured to provide command control signals to the microscope to position the stage. Reducing the amount of time needed to acquire a complete set of focal plane images by using a hardware controller circuit may enable the acquired data to more closely resemble simultaneous acquisition of the data, which facilitates spot detection by reducing the effect of motion over time on the spot detection process, as discussed in more detail below. However, it should be appreciated that capturing a z-stack of images may include any suitable number of focal-plane images.

Rather than sequentially obtaining a z-stack of images by physically moving the microscope stage, as discussed above, the 3D dataset may be captured with a microscope having multiple cameras, each of which simultaneously acquires data in a unique focal plane, which enables instantaneous collection of a 3D dataset, thereby removing the obscuring effect of object motion between capture of images at different focal planes. In one illustrative embodiment, a microscope having nine cameras and associated optics may be used to simultaneously acquire nine focal plane images. However, any suitable number of cameras (including two cameras) may be used to simultaneously acquire a z-stack of focal plane images, and embodiments are not limited in this respect. For example, in some embodiments, at least three cameras may be used.

In yet further embodiments, the 3D dataset may be acquired using a combination of multiple cameras and physically moving the microscope stage. Using multiple cameras reduces the time required to acquire a z-stack of images compared to single camera microscope embodiments. Using fewer cameras than would be required to simultaneously acquire all images in a z-stack (e.g., nine focal plane images) and combining the multi-camera microscope with stage repositioning may provide for a lower cost microscope compared to fully-simultaneous image capture microscope embodiments. For example, some embodiments may acquire the 3D dataset using a microscope having three cameras and use three different stage positions to acquire a nine focal-plane image 3D dataset. Any suitable number of cameras and physical positioning of the microscope stage may be used to acquire a 3D dataset, and embodiments are not limited in this respect.

In an embodiment involving the capture of images of one or more fluorescent spots, step 12 may include controlling a microscope, as noted above, and/or controlling a source of excitation radiation to activate the fluorophores to be imaged as fluorescent spots.

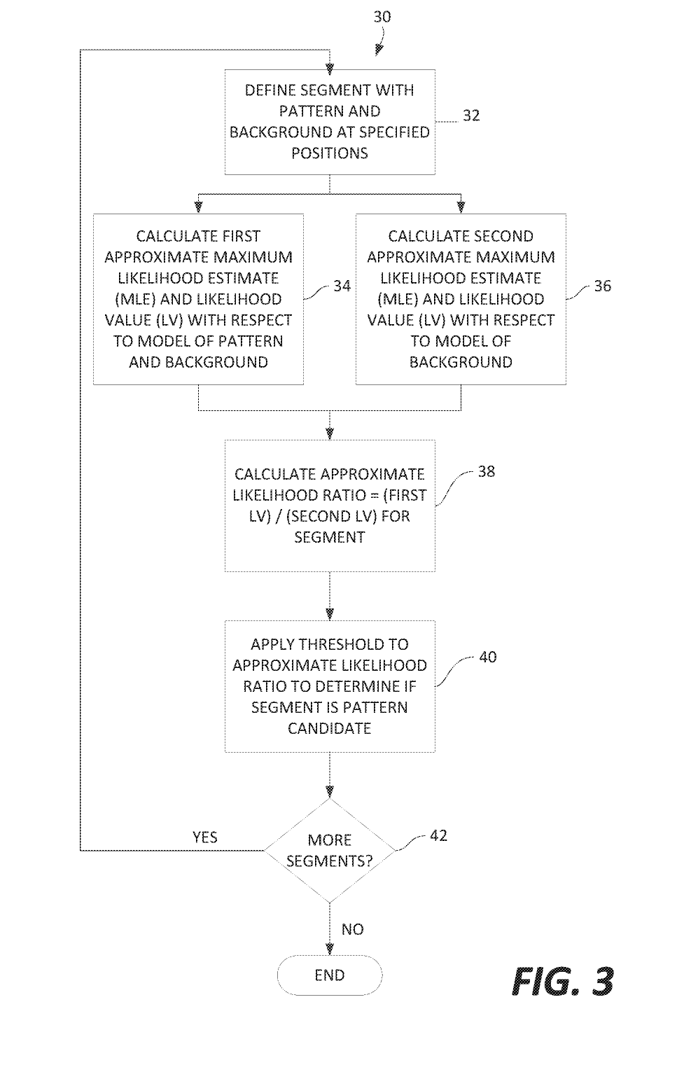

The method may further include a step 14 of applying an approximate Likelihood analysis to the data set to identify one or more pattern candidate segments. Applying an approximate Likelihood analysis to the data set may proceed according to stage I of the two-stage Likelihood pipeline described herein, in an embodiment. An example method that may be applied in step 14 will be described with respect to FIG. 3.

With continued reference to FIG. 1, step 14 may include dividing the data set into a plurality of segments and applying an approximate Likelihood analysis to each segment, in an embodiment. As noted above in this disclosure, a segment may include a set of adjacent, contiguous voxels, in an embodiment. In other embodiments, a segment may include non-adjacent or non-contiguous voxels or pixels or other portions of the data set. A result of the step may be, for each segment, a likelihood that each segment includes the pattern of interest (e.g., a fluorescent spot). If the likelihood that a given segment includes the pattern of interest is sufficiently high, the segment may be designated a “pattern candidate segment” for further processing.

The method 10 may further include a step 16 of applying a full Likelihood analysis to the pattern candidate segments identified in step 14 to characterize the pattern of interest. Step 16 may generally proceed according to stage II of the two-stage Likelihood pipeline described above. A result of step 16 may be one or more characterized patterns-of-interest. In an embodiment, a result of step 16 may be a location and amplitude of one or more patterns of interest, such as one or more fluorescent spots, as well as further confirmation of the existence of one or more patterns. Of course, in embodiments, no pattern of interest may actually be present in the data set, and the result of step 16 may be zero detected instances of the pattern of interest.

As noted above, the reduction in excitation enabled by the two-stage Likelihood pipeline approach consequently may reduce biological toxicity of the excitation energy and atomic degradation of fluorophores by the excitation energy, and therefore may allow for more frequent capture of more images over longer periods of time of imaging. Accordingly, embodiments that employ the spot detection techniques described herein also allow for acquisition of a larger number of images and, correspondingly, of imaging data with image capture at more frequent intervals over substantially longer timescales, which opens new possibilities for observing in vivo biological processes that unfold dynamically via rapid modulations over such longer timescales.

The steps 12, 14, 16 of the method 10 may be repeated over a period of time to track one or more patterns of interest over a plurality of data sets, with each data set comprising a 3D image of the same subject captured at a respective given point in time. In an embodiment, a visualization (e.g., a snapshot image, movie, etc.) of the characterized pattern of interest (e.g., of the characterized fluorescent spot) may be created.

FIG. 3 is a flow chart illustrating a method 30 of identifying one or more pattern candidate segments (i.e., segments that may contain a pattern of interest) in an N-dimensional data set. The method 30 may encompass an embodiment of stage I in a two-stage Likelihood pipeline analysis. Accordingly, as noted above, the method 30 may be applied at step 14 of the method 10 of FIG. 1. The method 30 may be applied to a data set that has been divided into segments (the nature of which is described in detail above) in order to identify one or more pattern candidate segments. The data set may be a 3D image data set and the pattern of interest may be, in an embodiment, one or more fluorescent spots.

The method 30 is illustrated and will be described with respect to its application to a single segment. Thus, the illustrated and below-described steps of the method may be applied to each of a plurality of segments in the data set, and the method may be repeated for each segment. Repetitions of the method 30 and/or steps of the method 30 may be performed serially or in parallel.

For a given segment, the method may include a step 32 of defining the segment as having the pattern of interest and background at respective specified positions within the segment. In an embodiment, the specified positions of the pattern of interest and background may be the same as each other. In other embodiments, the specified positions of the pattern of interest and background may be different from each other. In an embodiment, step 32 may include formulating a signal hypothesis and a null hypothesis having the form set forth in equations (9) and (10), respectively, for the segment. As noted above with respect to equations (9) and (10), formulating the signal and null hypotheses may include assuming that both the pattern of interest and the background are at respective specified positions within the segment, such as the center of the segment, for example. In embodiments, the pattern of interest and background may be assumed to be at the same specified position within the segment. In other embodiments, the pattern of interest and background may be assumed to be at different specified positions within the segment.

The method may further include a step 34 of calculating a first approximate Maximum Likelihood Estimate (MLE) with respect to a model of the pattern of interest and the background (i.e., the signal hypothesis model). Calculating the approximate MLE with respect to the signal hypothesis model may include formulating an approximate Likelihood function with respect to the signal hypothesis model that accounts for one or more sources of noise, in an embodiment. For example, the approximate Likelihood function for the signal hypothesis at step 34 may represent measurement noise (e.g., camera noise) as a Poisson distribution, may represent background noise as a Poisson distribution, and may represent pattern noise as a Poisson distribution. In an embodiment, step 34 may include formulating an approximate Likelihood function having the form in equation (23) and solving that approximate Likelihood function to determine optimal values of the approximate Likelihood function for the signal hypothesis at the segment, i.e., optimal values of the amplitude of the pattern of interest and the amplitude of the background at the segment. In this disclosure, the MLE of an approximate Likelihood function may be referred to as an approximate MLE. The approximate Likelihood function may also be solved to calculate an approximate Likelihood value (LV) for the segment, i.e., the likelihood that the data actually present at the segment arose from the signal hypothesis having the calculated optimal values.

The method may further include a step 36 of calculating a second approximate Maximum Likelihood Estimate (MLE) with respect to a model of the background, i.e., the null hypothesis model. Calculating the approximate MLE with respect to the null hypothesis model may include formulating an approximate Likelihood function with respect to the null hypothesis model that accounts for one or more sources of noise, in an embodiment. For example, the approximate Likelihood function for the null hypothesis at step 36 may represent measurement noise (e.g., camera noise) as a Poisson distribution and may represent background noise as a Poisson distribution. In an embodiment, step 34 may include formulating an approximate Likelihood function having the form in equation (23) (which, as noted above, can readily be modified by a person of skill in the art so as to apply to the null hypothesis) and solving that approximate Likelihood function to determine optimal values of the approximate Likelihood function for the null hypothesis at the segment, i.e., the optimal value of the amplitude of the background at the segment. The approximate Likelihood function may also be solved to calculate a Likelihood value (LV) for the segment, i.e., the likelihood that the data actually present at the segment arose from the null hypothesis having the calculated optimal background amplitude value.

The method may further include a step 38 of calculating an approximate Likelihood ratio. In an embodiment, the approximate Likelihood ratio may be the ratio of the Likelihood value associated with the first MLE (i.e., the MLE with respect to the signal hypothesis model) to the Likelihood value associated with the second MLE (i.e., the MLE with respect to the null hypothesis model).

The method may further include applying a threshold to the approximate Likelihood ratio to determine if the segment is a pattern candidate segment. The threshold may be applied to the approximate Likelihood ratio directly, in an embodiment. In other embodiments, the threshold may be applied to a derivation of the approximate Likelihood ratio, i.e., one or more values derived from or based on the approximate Likelihood ratio. If the approximate Likelihood ratio meets the threshold, the segment under examination may be designated as a candidate segment for further processing.

The method may further include a query step 42 at which it may be determined if further segments remain in the data set for initial examination according to the method 30. If there are additional segments, the method begins anew at step 32 with a new segment. If not, the method ends.

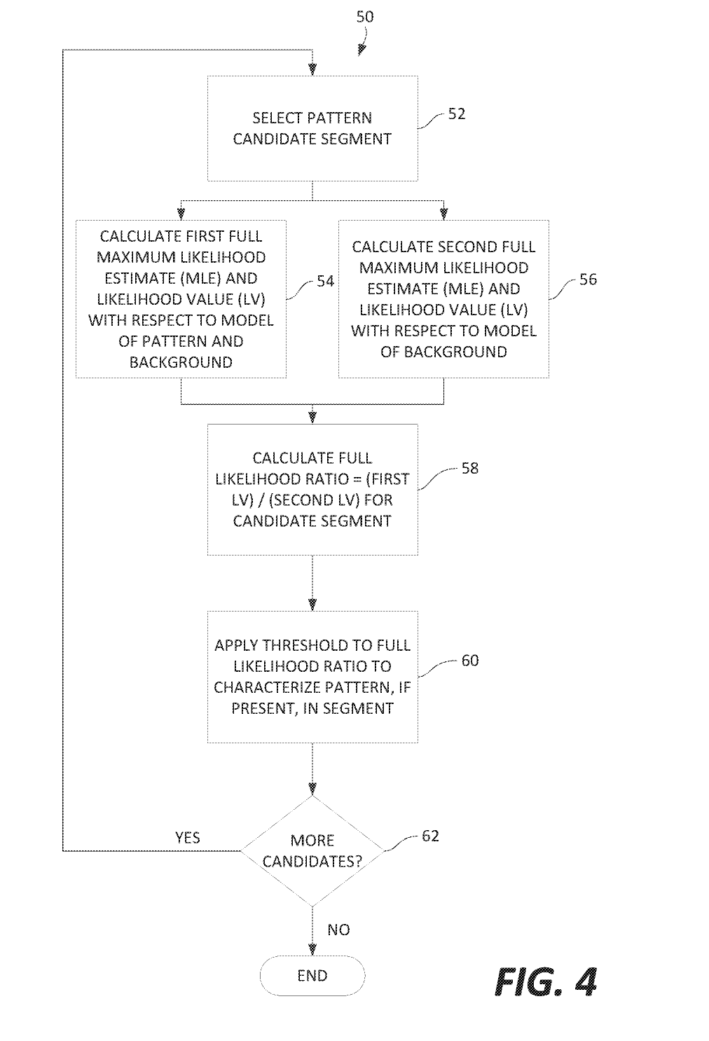

FIG. 4 is a flow chart illustrating a method 50 of detecting and characterizing a pattern of interest in an N-dimensional data set. The method 50 may encompass an embodiment of stage II in a two-stage Likelihood pipeline analysis. Accordingly, as noted above, the method 50 may be applied at step 16 of the method 10 of FIG. 1. The method 50 may be applied to one or more pattern candidate segments in a data set that have been identified according to, for example, the method 30 of FIG. 3. The data set may be a 3D image data set and the pattern of interest may be, in an embodiment, one or more fluorescent spots.

The method may include a step 52 of selecting a pattern candidate segment from a set of one or more pattern candidate segments. The remaining steps of the method 50 are illustrated and will be described with respect to its application to a single selected pattern candidate segment. Thus, the illustrated and below-described steps of the method 50 may be applied to each of one or more pattern candidate segments in the data set, and the method 50 may be repeated for each segment. Repetitions of the method 50 and/or steps of the method 50 may be performed serially or in parallel.

The method 50 may further include a step 54 of calculating a first full Maximum Likelihood Estimate (MLE) with respect to a model of the pattern of interest and the background (i.e., the signal hypothesis model). Calculating the full MLE with respect to the signal hypothesis model may include formulating a full Likelihood function with respect to the signal hypothesis model that accounts for one or more sources of noise, in an embodiment. For example, the full Likelihood function for the signal hypothesis at step 54 may represent measurement noise (e.g., camera noise) as a Gaussian distribution, may represent background noise as a Poisson distribution, and may represent pattern noise as a Poisson distribution. In an embodiment, step 54 may include formulating a full Likelihood function according to equation (34) and solving that full Likelihood function (e.g., through a hill-climbing exercise) to determine optimal values of the full Likelihood function for the signal hypothesis at the segment, i.e., optimal values of the amplitude of the pattern of interest, the location (e.g., the center of the distribution) of the pattern of interest, the amplitude of the background, and the location (e.g., the center of the distribution) of the background at the segment. In this disclosure, the MLE of a full Likelihood function may be referred to as a full MLE. The full Likelihood function may also be solved to calculate a Likelihood value for the segment, i.e., the likelihood that the data actually present at the segment arose from the signal hypothesis having the calculated optimal values.

The method may further include a step 56 of calculating a second full Maximum Likelihood Estimate (MLE) with respect to a model of the background, i.e., the null hypothesis model. Calculating the full MLE with respect to the null hypothesis model may include formulating a full Likelihood function with respect to the null hypothesis model that accounts for one or more sources of noise, in an embodiment. For example, the full Likelihood function for the null hypothesis at step 56 may represent measurement noise (e.g., camera noise) as a Gaussian distribution and may represent background noise as a Poisson distribution. In an embodiment, step 56 may include formulating an full Likelihood function according to equation (34) (which, as noted above, can readily be modified by a person of skill in the art so as to apply to the null hypothesis) and solving that full Likelihood function to determine optimal values of the full Likelihood function for the null hypothesis at the segment, i.e., the optimal value of the amplitude and position of the background at the segment. The full Likelihood function may also be solved to calculate a Likelihood value for the segment, i.e., the likelihood that the data actually present at the segment arose from the null hypothesis having the calculated optimal background amplitude value and position.

The method may further include a step 58 of calculating a full Likelihood ratio. In an embodiment, the full Likelihood ratio may be the ratio of the Likelihood value associated with the first MLE (i.e., the full MLE with respect to the signal hypothesis model) to the Likelihood value associated with the second MLE (i.e., the full MLE with respect to the null hypothesis model).

The method 50 may further include a step 60 of applying a threshold to the full Likelihood ratio to determine if the pattern is present in the segment. The threshold may be applied to the full Likelihood ratio directly, in an embodiment. In other embodiments, the threshold may be applied to a derivation of the full Likelihood ratio, i.e., one or more values derived from or based on the full Likelihood ratio. If the full Likelihood ratio meets the threshold, the pattern of interest may be considered detected in the candidate segment under examination, and the optimal values of the first full MLE (i.e., the full MLE respective of the signal hypothesis) may be considered the characteristics of the pattern of interest and the background at the segment.

The method may further include a query step 62 at which it may be determined if further pattern candidate segments remain in the data set for further examination according to the method 50. If there are additional segments, the method begins anew at step 62. If not, the method ends.

Embodiments that address detecting and characterizing fluorescent spots may enable direct 3D spot-based super-resolution time-lapse imaging, with spots of two or more fluorescence colors, with unprecedented temporal resolution and duration, in living samples. The defining feature of spot-based super-resolution imaging is very precise specification of the position of a spot, i.e. its “localization.” However, imaged entities move due to thermal forces or, in living cells, more dramatically due to energy-driven effects. Super-resolution 3D imaging may involve acquisition 2D images in each of multiple focal planes. If the different focal planes are imaged sequentially, an imaged entity may move during the process of 3D data collection and such movement will compromise the precision with which a spot can be localized. This effect may be eliminated if 2D datasets are captured in all focal planes simultaneously, which in turn can be accomplished by a microscope having multiple cameras, one per focal plane, which capture images in perfect coordination.

Super-resolution imaging involves acquisition of images in multiple focal planes, as discussed above. Although these images are obtained in rapid succession, the elapsed time between images may be a significant fraction of the total time involved. Since effective super-resolution time-lapse imaging requires minimization of total excitation energy, and thus total illumination time, it is desirable for the sample to be excited only when an image is actually being captured and not during the intervening periods. This outcome can be accomplished by a suitable combination of hardware and software in which the camera and the light source are in direct communication, without intervening steps involving signals to and from a computer, such that the sample is excited by light only at the same instant that the camera is taking a picture. For simultaneous imaging in multiple focal planes, this direct communication between camera and light source must occur synchronously for all of the multiple cameras responsible for imaging at the multiple focal planes as described above.

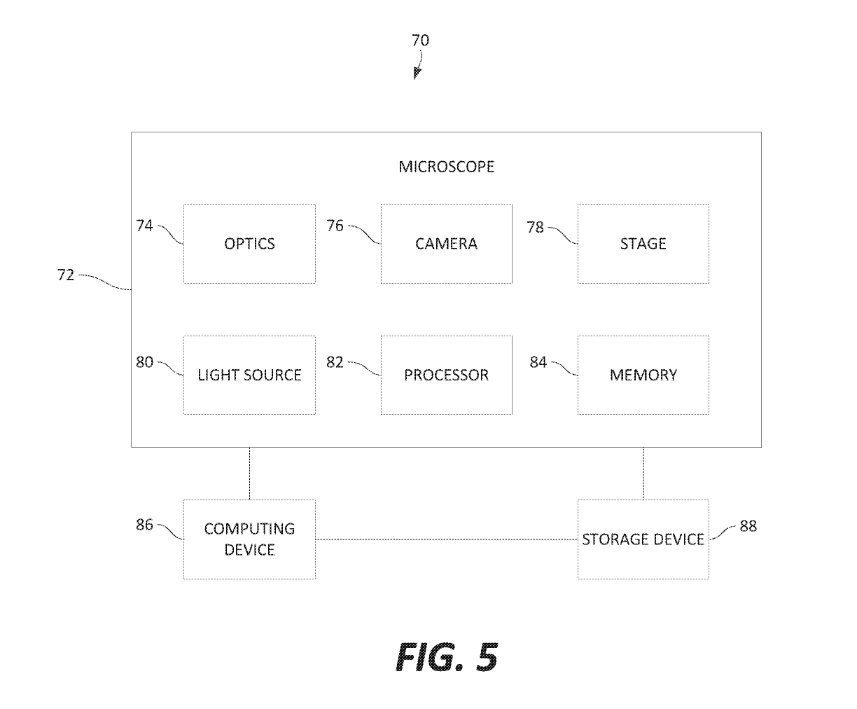

FIG. 5 is a diagrammatic view of an embodiment of a system 70 for acquiring a data set and identifying and localizing a pattern of interest in a data set. As discussed above, a non-limiting 3D dataset that may be analyzed in accordance with the techniques described herein using 3D pattern matching may be acquired using any suitable fluorescence imaging microscope configured to acquire a plurality of 2D focal plane images in a z-stack. The system 70 of FIG. 5 includes a microscope 72 that may be used to acquire such a 3D dataset in accordance with some embodiments. Microscope 72 may include optics 74, which may include lenses, mirrors, or any other suitable optics components needed to receive magnified images of biological specimens under study. In some embodiments, optics 74 may include optics configured to correct for distortions (e.g., spherical aberration).

Microscope 70 also includes stage 78 on which one or more biological specimens under study may be placed. For example, stage 78 may include component(s) configured to secure a microscope slide including the biological specimen(s) for observation using the microscope. In some embodiments, stage 78 may be mechanically controllable such that the stage may be moved in the z-direction to obtain images at different focal planes, as discussed in more detail below.

Microscope 70 also includes a light source 80. The light source 80 may be configured to provide excitation energy to illuminate a biological sample placed on stage 78 to activate fluorophores attached to biological structures in the sample. In an embodiment, the light source may be a laser. In some embodiments, the light source 80 may be configured to illuminate the biological sample using light of a wavelength different than that used to acquire images of photons released by the fluorophores. For example, some fluorescent imaging techniques such as stochastic optical reconstruction microscopy (STORM) and photoactivated location microscopy (PALM), employ different fluorophores to mark different locations in a biological structure, and the different fluorophores may be activated at different times based on the characteristics (e.g., wavelength) of the light produced by the light source used to illuminate the sample. In such instances, the light source 80 may include at least two light sources, each of which is configured to generate light having different characteristics for use in STORM or PALM-based imaging. In other embodiments, a single tunable light source may be used.

The microscope 72 may also include a camera 76 configured to detect photons emitted from the fluorophores and to construct 2D images. Any suitable camera(s) may be used including but not limited to, CMOS or CCD-based cameras. As discussed above, some embodiments may include a single camera with a controllable microscope stage to time sequentially acquire images in a z-stack as the stage moves positions, whereas other embodiments may include multiple cameras, each of which is configured such that the multiple cameras simultaneously acquire 2D images in appropriate different focal planes, thus creating a z-stack instantaneously without any time delay between the 2D images throughout the stack.

The microscope 72 may also include a processor 82 programmed to control the operation of one or more of stage 78, light source 80, and camera 76. The processor 82 may be implemented as a general- or special-purpose processor programmed with instructions to control the operation of one or more components of the microscope 72. Alternatively, the processor 82 may be implemented, at least in part, by hardware circuit components arranged to control operation of one or more components of the microscope.

The microscope 72 may further include a memory 84 which may be or may include a volatile or non-volatile computer-readable medium. The memory 84 may temporarily or permanently store one or more images captured by the microscope 72. The memory 84 may additionally or alternatively store one or more instructions for execution by the processor 82. The instructions may encompass or embody one or more of the methods of this disclosure (e.g., one or more of methods 10, 30, 50, any portions thereof, and/or any portions of the two-stage Likelihood pipeline disclosed herein).

In addition to or instead of a processor 82 and memory 84, the microscope may include one or more additional computing devices. For example, in embodiments, the microscope 72 may include one or more of an application-specific integrated circuit (ASIC), a field-programmable gate array (FPGA), and/or another type of processing device.

Although the components of the microscope 72 (i.e., the optics 74, camera 76, stage 78, light source 80, processor 82, and memory 84) are generally described above as singular, it should be understood that any of the components of the microscope 72 may be provided in multiple. That is, the microscope may include multiple optics 74, cameras 76, stages 78, light sources 80, processors 82, and/or memories 84.

In an embodiment, the microscope may include multiple optics 74 and multiple cameras 76, with each set of optics 74 paired with a respective camera 76. Each paired optics 74 and camera 76 may be configured for imaging in a specific focal plane, with the focal plane of each paired optics 74 and camera 76 different from each other pair. In such an embodiment, the system 70 may enable simultaneous imaging in multiple focal planes for, e.g., capture of a z-stack of images at a single point in time.

In an embodiment, the processor 82 may control the light source 80 and camera 76 so as to enable simultaneous application of excitation energy from the light source 80 and imaging with the camera 76. As noted above, in an embodiment, the microscope may include multiple cameras 76. Accordingly, in an embodiment, the processor 82 may control the light source 80 and multiple cameras 76 configured to image different respective imaging planes so as to simultaneously image in multiple focal planes with simultaneous application of excitation energy from the light source 80. Such an arrangement, in conjunction with the techniques for processing the subsequent images of this disclosure, may enable super-resolution imaging for long periods of time of the same biological sample.

In addition to the microscope 72, the system 70 may further include a computing device 86 and a storage device 88, both in electronic communication with the microscope 72. The storage device 88 may be configured to store image data acquired by the camera 76. The storage device 88 may be integrated with or directly connected to the microscope 72 as local storage and/or the storage device 88 may be located remote to microscope 72 as remote storage in communication with microscope 72 using one or more networks. In some embodiments, the storage device 88 may be configured to store a plurality of 3D images of a fluorescent spot.

The computing device 86 may be in communication with microscope 72 using one or more wired or wireless networks. The computing device 86 may be or may include, for example only, a laptop computer, a desktop computer, a tablet computer, a smartphone, a smart watch, or some other electronic computing device. In some embodiments, the computing device 86 may be configured to control one or more operating parameters of the microscope 72 using applications installed on the computing device. In some embodiments, the computing device 86 may be configured to receive imaging data captured using the microscope 72.

The computing device 86 may include its own respective processor and memory and/or other processing devices for storage and execution of one or more methods or techniques of this disclosure. For example, the computing device 86 may store and execute one or more instructions. The instructions may encompass or embody one or more of the methods of this disclosure (e.g., one or more of methods 10, 30, 50, any portions thereof, and/or any portions of the two-stage Likelihood pipeline disclosed herein). The computing device may be in electronic communication with the storage device 88, in embodiments, in order to acquire one or more data sets from the storage device 88 for processing.

In some embodiments, a time-lapse visualization (e.g., a movie) may be created (e.g., by the computing device 86) to visualize the tracked location of an imaged entity as identified by processing the 4D dataset. In one implementation, the time-lapse visualization may be created based, at least in part, on a plurality of point-in-time visualizations created in accordance with the techniques described above. In an embodiment, such a visualization may include a plot of one or more of the MLE parameters of a model (e.g., a signal hypothesis model). For example, plotting the value of A (see equations (1) and (9) above) would provide a visualization of the amplitude of a pattern of interest.

Experimental Results of Two-Stage Likelihood Pipeline.

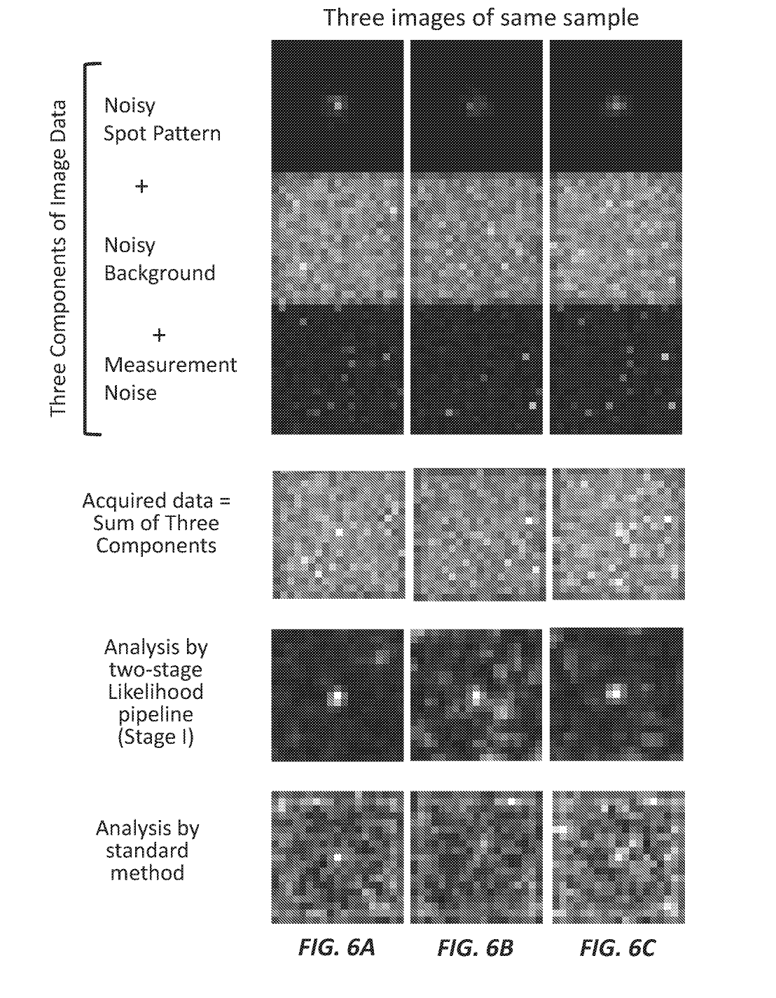

The performance of the two-stage Likelihood pipeline has been experimentally benchmarked in relation to known methodologies using synthetic data sets. FIG. 6A, FIG. 6B and FIG. 6C are example images (each of which is a two-dimensional projection of an in silico 3D data set) illustrating the efficacy of the two-stage pipeline approach. Each of FIGS. FIG. 6A, FIG. 6B, and FIG. 6C includes a single column of six rows, with each row including an image. Each column describes the components of, and analysis of, a single image. Thus, FIG. 6A, FIG. 6B, and FIG. 6C describe three independent images of the same sample.

In each column of FIG. 6A, FIG. 6B, and FIG. 6C, the first row includes an image of a noisy spot pattern (i.e., the pattern of interest which is noisy due to quantum fluctuations in photons detected per capture time). The second row includes an image of a noisy background, and the third row includes an image of measurement noise. As can be seen in FIG. 6A, FIG. 6B, and FIG. 6C, rows 1-3, the data output from image-to-image within a single sample can vary significantly due to the existence of noise. The fourth row illustrates the combined data of the first three—i.e., the acquired data set based on the noisy pattern, noisy background, and measurement noise. The fifth row illustrates the result of stage I of a two-stage Likelihood pipeline approach according to this disclosure. More specifically, the fifth row illustrates a Likelihood ratio landscape (i.e., the result of determining a Likelihood ratio for each segment of the data sets in the fourth row). In the application of the stage I analyses reflected in FIG. 6A, FIG. 6B, and FIG. 6C, each acquired 3D data set was divided into 19×19×19 patches, with each voxel in the data set having a dedicated patch, and with each patch centered on a voxel and including 7×7×7 adjacent voxels. For comparison, the sixth row illustrates the result of an analysis of the same data sets shown in the fourth row according to a known method.

In summary, FIG. 6A, FIG. 6B, and FIG. 6C illustrate numerous components (i.e., the noisy spot pattern, noisy background, and measurement noise) that may be accounted for in Likelihood functions for the signal and null hypotheses in a two-stage Likelihood pipeline according to the present disclosure. FIG. 6A, FIG. 6B, and FIG. 6C further illustrate a consequence of an example application of approximate Likelihood functions to a 3D fluorescence imaging data set in order to determine the Likelihood ratio landscape at Stage I of a two-stage Likelihood pipeline analysis.

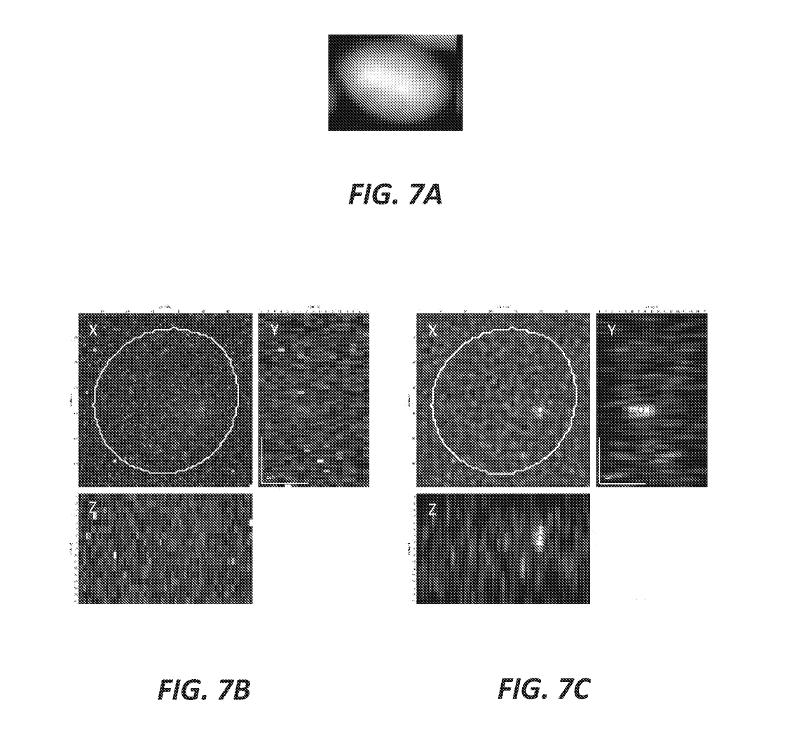

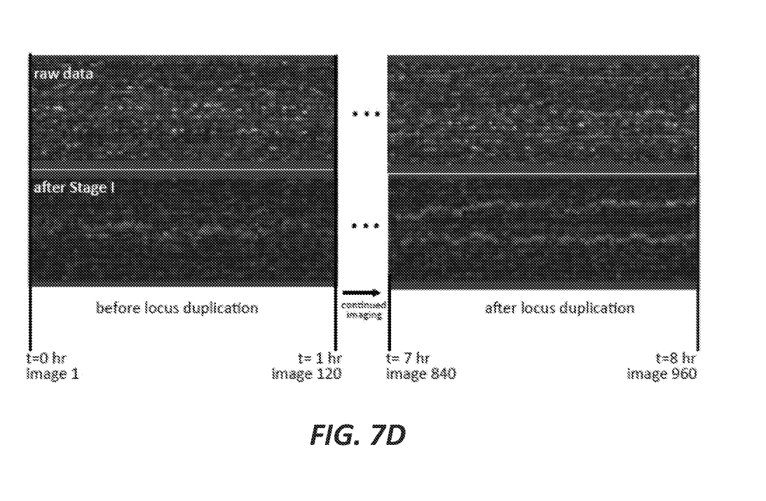

FIG. 7A is an image of a living cell of budding yeast (S.cerevisiae) carrying a fluorescent tag at a single position on one of its chromosomes. FIG. 7B represents a single 3D image data set of the fluorescence pattern of the cell in FIG. 7A. The three panels are three 2D projections of that data, in the x, y and z dimensions, respectively, as indicated. FIG. 7C represents the processing of the 3D data set of FIG. 7B according to an example application of stage I of the two stage Likelihood pipeline. A 3D Likelihood ratio landscape was generated, corresponding to the 3D data set. The three panels are three 2D projections of that 3D Likelihood ratio landscape, in the x, y and z dimensions, respectively, as indicated. As can be seen by comparing FIG. 7B with FIG. 7C, application of stage I of the two-stage Likelihood pipeline to the data set can reveal the presence of a fluorescent spot in FIG. 7C which was not visible by eye in the noisy raw image data set of FIG. 7B.

In an experiment, the cell was imaged in 3D every thirty seconds for eight hours, with seventeen focal planes per image. FIG. 7D includes kymograph images, with time on the x-axis and a one-dimensional maximum brightness projection of the 3D data (achieved by a first projection in the z dimension and a second projection in the y dimension), illustrating the results of the experiment. FIG. 7D includes two image rows. The first row includes the raw captured image data and the second row includes the Likelihood landscape following stage I of an example two-stage Likelihood pipeline. Finally, in both rows, a left portion includes images of the yeast cell before locus duplication (hence a single spot), and the right portion includes images of the yeast cell after locus duplication (hence two spots).

FIG. 7D shows that spots are revealed (as in FIG. 7C) at all of the 960 images captured over the 8 hour imaging period described in FIG. 7D.

FIG. 8 includes three different versions of a single image of a living cell of the bacterium E. coli. The single chromosome (nucleoid) of the cell was tagged by a fluorescent chromosome binding protein (HU-mCherry). The first, left-most image in FIG. 8 is a raw captured image of the cell. The middle image is a result of applying an AUTOQUANT deconvolution to the raw image. The third, right-most image is a Likelihood ratio landscape resulting from an application of an example stage I analysis of a two-stage Likelihood pipeline to the raw image.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method of detecting a pattern of interest in a data set, the data set comprising a plurality of segments, the method comprising:
calculating an approximate maximum likelihood estimate (MLE) for one or more of the plurality of segments to identify one or more pattern-of-interest candidate segments, wherein calculating an approximate MLE for a segment comprises assuming that the pattern of interest is positioned at a specified position in the segment;
applying a full Likelihood analysis to each of the candidate segments; and designating one or more of the candidate segments as including the pattern according to the result of the full Likelihood analysis.

2. The method of claim 1, wherein the approximate MLE is a first approximate MLE and the specified position is a first specified position, wherein calculating the first approximate MLE for a segment further comprises:
calculating the first approximate MLE for the segment with respect to a first model, the first model comprising (i) the pattern of interest at the segment and (ii) a background pattern at the segment,
wherein calculating the first approximate MLE comprises assuming that the background pattern is positioned at a second specified position in the segment;
wherein the method further comprises:
calculating a second approximate MLE for the segment with respect to a second model, the second model comprising the background pattern at the segment;
calculating a first approximate likelihood value (LV) associated with the first approximate MLE;
calculating a second approximate LV associated with the second approximate MLE; and
determining a ratio of the first approximate LV to the second approximate LV.

3. The method of claim 2, wherein identifying one or more candidate segments comprises:
computing, for each of the one or more of the plurality of segments, a respective ratio of the first approximate LV to the second approximate LV;
comparing, for each of the one or more of the plurality of segments, the respective ratio or a derivative of the ratio to a threshold; and
identifying, for each of the one or more of the plurality of segments, the segment as a pattern of interest candidate segment if the respective ratio exceeds the threshold.

4. The method of claim 2,
wherein calculating the first approximate MLE for the segment comprises representing one or more types of noise as one or more statistical distributions; and
wherein calculating the second approximate MLE for the segment comprises representing one or more types of noise as one or more statistical distributions.

5. The method of claim 4,
wherein calculating the first approximate MLE for the segment comprises representing measurement noise as a Poisson distribution; and
wherein calculating the second approximate MLE for the segment comprises representing measurement noise as a Poisson distribution.

6. The method of claim 1, wherein applying a full Likelihood analysis to a pattern candidate segment comprises:
calculating a first full MLE for the segment with respect to a full model of (i) the pattern of interest at the segment and (ii) a background pattern at the segment;
calculating a first full likelihood value (LV) associated with the first full MLE;
calculating a second full MLE for the segment with respect to a full model of the background pattern at the segment;
calculating a second full LV associated with the second full MLE; and
determining a ratio of the first full LV to the second full LV.

7. The method of claim 6,
wherein calculating the first full MLE for the segment comprises:
representing pattern noise as a Poisson distribution;
representing background noise as a Poisson distribution; or
representing pattern noise as a Poisson distribution and representing background noise as a Poisson distribution;
wherein calculating the first full MLE further comprises representing measurement noise as a Gaussian distribution; and
wherein calculating the second full MLE for the segment comprises representing background noise as a Poisson distribution and representing measurement noise as a Gaussian distribution.

8. The method of claim 1, wherein the data set comprises N-dimensional image data and each segment comprises an N-dimensional portion of the image data.

9. A system comprising:
a non-transitory computer-readable medium storing instructions; and
a processor configured to execute the instructions to perform a method of detecting a pattern in a data set, the data set comprising a plurality of segments, the method comprising:
calculating an approximate maximum likelihood estimate (MLE) for one or more of the plurality of segments to identify one or more pattern-of-interest candidate segments, wherein calculating an approximate MLE for a segment comprises assuming that the pattern of interest is positioned at a specified position in the segment;
applying a full Likelihood analysis to each of the candidate segments; and designating one or more of the candidate segments as including the pattern according to the result of the full Likelihood analysis.

10. The system of claim 9, wherein the approximate MLE is a first approximate MLE and the specified position is a first specified position, wherein calculating the first approximate MLE for a segment further comprises:
calculating the first approximate MLE for the segment with respect to a first model, the first model comprising (i) the pattern of interest at the segment and (ii) a background pattern at the segment,
wherein calculating the first approximate MLE comprises assuming that the background pattern is positioned at a second specified position in the segment;
wherein the method further comprises:
calculating a second approximate MLE for the segment with respect to a second model, the second model comprising the background pattern at the segment;
calculating a first approximate likelihood value (LV) associated with the first approximate MLE;
calculating a second approximate LV associated with the second approximate MLE and
determining a ratio of the first approximate LV to the second approximate LV.

11. The system of claim 10, wherein identifying one or more candidate segments comprises:
determining, for each of the one or more of the plurality of segments, a respective ratio of the first approximate LV for the segment to the second approximate LV for the segment;
comparing, for each of the one or more of the plurality of segments, the respective ratio or a derivative of the ratio to a threshold; and
identifying, for each of the one or more of the plurality of segments, the segment as a pattern of interest candidate segment if the respective ratio exceeds the threshold.

12. The system of claim 10,
wherein calculating the first approximate MLE for the segment comprises representing one or more types of noise as one or more statistical distributions; and
wherein calculating the second approximate MLE for the segment comprises representing one or more types of noise as one or more statistical distributions.

13. The system of claim 12,
wherein calculating the first approximate MLE for the segment comprises representing measurement noise as a Poisson distribution; and
wherein calculating the second approximate MLE for the segment comprises representing measurement noise as a Poisson distribution.

14. The system of claim 9, wherein applying a full Likelihood analysis to a pattern candidate segment comprises:
calculating a first full MLE for the segment with respect to a full model of (i) the pattern of interest at the segment and (ii) a background pattern at the segment;
calculating a first full likelihood value (LV) associated with the first full MLE;
calculating a second full MLE for the segment with respect to a full model of the background pattern at the segment;
calculating a second full LV associated with the second full MLE; and
determining a ratio of the first full LV to the second full LV.

15. The system of claim 14,
wherein calculating the first full MLE for the segment comprises:
representing pattern noise as a Poisson distribution;
representing background noise as a Poisson distribution; or
representing pattern noise as a Poisson distribution and representing background noise as a Poisson distribution;
wherein calculating the first full MLE further comprises representing measurement noise as a Gaussian distribution; and
wherein calculating the second full MLE for the segment comprises representing background noise as a Poisson distribution and representing measurement noise as a Gaussian distribution.

16. The system of claim 10, further comprising:
an image capture device in electronic communication with the processor and configured to provide one or more images to the processor;
wherein the processor is configured to store the one or more images in the memory as the data set.

17. A method of detecting a pattern of interest in a data set, the data set comprising a plurality of segments, the method comprising:
calculating a first approximate maximum likelihood estimate (MLE) for one or more of the plurality of segments with respect to a first model, the first model comprising (i) the pattern of interest at the segment and (ii) a background pattern at the segment, wherein calculating the first approximate MLE for a segment comprises assuming that the pattern of interest is positioned at a specified position in the segment;
calculating a first approximate likelihood value (LV) associated with the first approximate MLE;
calculating a second approximate MLE for the one or more segments with respect to a second model, the second model comprising the background pattern at the segment;
calculating a second approximate LV associated with the second approximate MLE;
determining a ratio of the first approximate LV to the second approximate LV to identify one or more pattern-of-interest candidate segments,;
applying a full Likelihood analysis to each of the candidate segments; and designating one or more of the candidate segments as including the pattern of interest according to the result of the full Likelihood analysis.

18. The method of claim 17,
wherein the specified position is a first specified position;
wherein calculating the first approximate MLE for a segment further comprises assuming that the background pattern is positioned at a second specified position of the segment; and
wherein calculating the second approximate MLE for a segment further comprises assuming that the background pattern is positioned at the second specified position.

19. The method of claim 17,
wherein calculating the first approximate MLE for a segment comprises representing measurement noise as a Poisson distribution; and
wherein calculating the second approximate MLE for a segment comprises representing measurement noise as a Poisson distribution.

20. The method of claim 17, wherein applying a full Likelihood analysis to a pattern candidate segment comprises:
calculating a first full MLE for the segment with respect to a full model of (i) the pattern of interest at the segment and (ii) the background pattern at the segment;
calculating a first full likelihood value (LV) associated with the first full MLE;
calculating a second full MLE for the segment with respect to a full model of the background pattern at the segment;
calculating a second full LV associated with the second full MLE; and
determining a ratio of the first full LV to the second full LV.
